(19) United States
(12) Patent Application Publication
(10) Pub. No.: US 2008/0292969 A1
(43) Pub. Date: Nov. 27, 2008

(54) GEL ELECTROLYTE SECONDARY BATTERY

(75) Inventors: Tamami Mori, Fukushima (JP); Fumiko Kimura, Fukushima (JP); Keizo Koga, Fukushima (JP); Yayoi Horiuchi, Fukushima (JP)

Correspondence Address: BELL, BOYD & LLOYD, LLP, P. O. BOX 1135, CHICAGO, IL, 60690, US

(73) Assignee: Sony Corporation, Tokyo (JP)

(21) Appl. No.: 12/121,483

(22) Filed: May 15, 2008

(30) Foreign Application Priority Data
May 23, 2007 (JP) 2007-136090

(51) Int. Cl. H01M 6/14

(52) U.S. Cl. 429/303

(57) ABSTRACT

A gel electrolyte secondary battery includes a positive electrode, a negative electrode containing a binder-containing negative electrode mixture and a gel non-aqueous electrolyte, wherein the binder contains polyvinylidene fluoride and polyacrylonitrile or a styrene-butadiene rubber.

### CROSS REFERENCES TO RELATED APPLICATIONS

The present application claims priority to Japanese Patent Application JP 2007-136090 filed in the Japan Patent Office on May 23, 2007, the entire contents of which being incorporated herein by reference.

### BACKGROUND

The present disclosure relates to a gel electrolyte secondary battery and in more detail, to a gel electrolyte secondary battery containing polyvinylidene fluoride and polyacrylonitrile or a styrene-butadiene rubber as a binder of a negative electrode.

In recent years, a number of portable electronic devices such as camcorders (video tape recorders), digital still cameras, cellular phones, personal digital assistants and notebook computers, each achieving a reduction in size and weight, have appeared. With respect to batteries, in particular, secondary batteries as a portable power source for such electronic devices, intensive studies have been conducted for the purpose of enhancing the energy density.

Above all, lithium ion secondary batteries using carbon for a negative electrode active substance, a lithium-transition metal composite oxide for a positive electrode active substance and a carbonic ester mixture for an electrolytic liquid have been widely put to practical use because they are able to obtain a high energy density as compared with lead batteries and nickel-cadmium batteries which are a related-art aqueous electrolytic liquid secondary battery (see, for example, JP-A-4-332479).

In particular, laminate type secondary batteries using a laminated film for an exterior are lightweight, and therefore, the energy density is high (see, for example, Japanese Patent No. 3482591).

In such laminate type secondary batteries, when a polymer swollen by an electrolytic liquid is used, the interface between an electrode and an electrolyte is fixed, and a battery element itself has self-supporting properties, and therefore, the deformation of the battery can be controlled (see, for example, JP-A-2001-167797).

On the other hand, it is proposed to use a styrene-butadiene rubber as a binder of a negative electrode (see, for example, JP-A-2000-285925); and furthermore, it is proposed to use polyacrylonitrile as a binder of a negative electrode (see, for example, JP-A-2005-327630).

However, in case of using, as a binder of a negative electrode, only a styrene-butadiene rubber or only polyacrylonitrile, there was involved a problem that when applied to a gel non-aqueous electrolyte, the compatibility between the gel non-aqueous electrolyte and the negative electrode is low, whereby a load characteristic or a cycle characteristic is lowered.

It is desirable to provide a gel electrolyte secondary battery capable of keeping the compatibility between a gel non-aqueous electrolyte and a negative electrode, having a high capacity and having a satisfactory load characteristic or cycle characteristic.

### SUMMARY

It has been found that the foregoing desire can be achieved by containing, as a binder of a negative electrode, polyvinylidene fluoride and polyacrylonitrile or a styrene-butadiene rubber, according to an embodiment.

A gel electrolyte secondary battery according to an embodiment is a gel electrolyte secondary battery including a positive electrode, a negative electrode containing a binder-containing negative electrode mixture and a gel non-aqueous electrolyte, wherein the binder contains polyvinylidene fluoride and polyacrylonitrile or a styrene-butadiene rubber.

According to the embodiment, since polyvinylidene fluoride and polyacrylonitrile or a styrene-butadiene rubber are contained as the binder of the negative electrode, it is possible to provide a gel electrolyte secondary battery capable of keeping the compatibility between a gel non-aqueous electrolyte and a negative electrode, having a high capacity and having a satisfactory load characteristic or cycle characteristic.

Additional features and advantages are described herein, and will be apparent from the following Detailed Description and the figures.

### BRIEF DESCRIPTION OF THE FIGURES

FIG. 1 is an exploded perspective view showing one example of a laminate type secondary battery which is a non-aqueous electrolyte secondary battery according to an embodiment.

FIG. 2 is a schematic cross-sectional view showing the battery element as shown in FIG. 1 along an II-II line thereof.

### DETAILED DESCRIPTION

The gel electrolyte secondary battery according to an embodiment is hereunder described. In the specification and appended claims, the term “%” in concentrations and contents and the like means a percent by mass unless otherwise indicated.

As described previously, the gel electrolyte secondary battery according to an embodiment is a gel electrolyte secondary battery including a positive electrode, a negative electrode containing a binder-containing negative electrode mixture and a gel non-aqueous electrolyte, wherein the binder contains polyvinylidene fluoride and polyacrylonitrile or a styrene-butadiene rubber.

Also, in a first preferred embodiment of the gel electrolyte secondary battery, the gel non-aqueous electrolyte contains a matrix polymer; and examples of the matrix polymer include a copolymer of polyvinylidene fluoride and hexafluoropropylene, a copolymer of polyvinylidene fluoride, hexafluoropropylene and monochlorotrifluoroethylene, a copolymer of polyvinylidene fluoride, hexafluoropropylene and monomethyl maleate and mixtures composed of an arbitrary combination thereof.

Furthermore, in a second preferred embodiment of the gel electrolyte secondary battery, the binder contains polyvinylidene fluoride and polyacrylonitrile; the total content of polyvinylidene fluoride and polyacrylonitrile is from 2.0 to 6.5% on the basis of the whole content of a negative electrode mixture; and a ratio of polyvinylidene fluoride to polyacrylonitrile is from 5/95 to 95/5 in terms of a weight ratio.

Moreover, in a third preferred embodiment of the gel electrolyte secondary battery, the binder contains polyvinylidene fluoride and a styrene-butadiene rubber; the total content of polyvinylidene fluoride and the styrene-butadiene rubber is from 2.5 to 6.5% on the basis of the whole content of a negative electrode mixture; and a ratio of polyvinylidene fluoride to the styrene-butadiene rubber is from 90/10 to 30/70 in terms of a weight ratio.

Certain embodiments of the gel electrolyte secondary battery are hereunder described in detail with reference to the accompanying drawings.

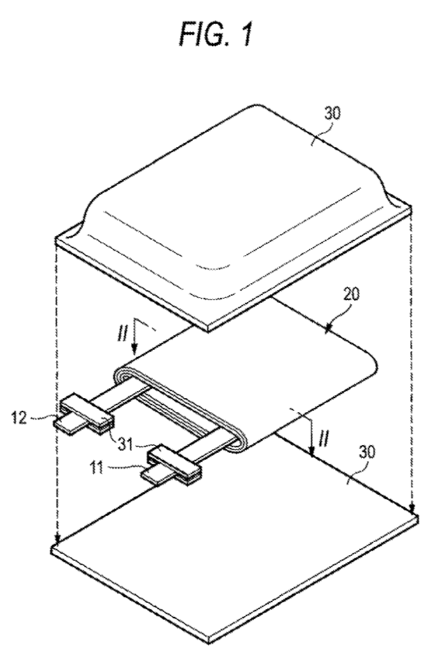

FIG. 1 is an exploded perspective view showing one example of a laminate type secondary battery which is a gel electrolyte secondary battery according to an embodiment.

As shown in FIG. 1, this secondary battery is configured in such a manner that a battery element 20 having a negative electrode terminal 11 and a positive electrode terminal 12 installed therein is charged in the inside of an exterior member 30 in a film state. The negative electrode terminal 11 and the positive electrode terminal 12 are each derived in, for example, the same direction from the inside towards the outside of the exterior member 30. The negative electrode terminal 11 and the positive electrode terminal 12 are each constituted of a metal material such as aluminum (Al), copper (Cu), nickel (Ni) and stainless steel (SUS).

The exterior member 30 is constituted of a rectangular laminated film obtained by sticking, for example, a nylon film, an aluminum foil and a polyethylene film in this order. The exterior member 30 is, for example, provided in such a manner that the polyethylene film side and the battery element 20 are disposed opposing to each other, and respective external edges thereof are joined with each other by fusion or an adhesive.

An adhesive film 31 is inserted between the exterior member 30 and each of the negative electrode terminal 11 and the positive electrode terminal 12 for the purpose of preventing invasion of the outside air. The adhesive film 31 is constituted of a material having adhesiveness to the negative electrode terminal 11 and the positive electrode terminal 12, and for example, in the case where the negative electrode terminal 11 and the positive electrode terminal 12 are each constituted of the foregoing metal material, it is preferable that the adhesive film 31 is constituted of a polyolefin resin, for example, polyethylene, polypropylene, modified polyethylene and modified polypropylene.

The exterior member 30 may also be constituted of a laminated film having other structure, for example, a metal material-free laminated film, a high-molecular film such as polypropylene or a metal film in place of the foregoing laminated film.

Here, a general configuration of the exterior member can be expressed by a laminate structure of exterior layer/metal foil/sealant layer (however, the exterior layer and the sealant layer are sometimes configured of plural layers). In the foregoing example, the nylon film is corresponding to the exterior layer, the aluminum foil is corresponding to the metal foil, and the polyethylene film is corresponding to the sealant layer.

It is sufficient that the metal foil functions as a barrier membrane having water vapor permeation resistance. As the metal foil, not only the aluminum foil but a stainless steel foil, a nickel foil and a plated iron foil are useful. Of these, the aluminum foil which is lightweight and excellent in workability can be favorably used.

Examples of a mode of the configuration (exterior layer/metal foil/sealant layer) which can be used as the exterior member include Ny (nylon)/Al (aluminum)/CPP (cast polypropylene), PET (polyethylene terephthalate)/Al/CPP, PET/Al/PET/CPP, PET/Ny/Al/CPP, PET/Ny/Al/Ny/CPP, PET/Ny/Al/Ny/PE (polyethylene), Ny/PE/Al/LLDPE (linear low density polyethylene), PET/PE/Al/PET/LDPE (low density polyethylene) and PET/Ny/Al/LDPE/CPP.

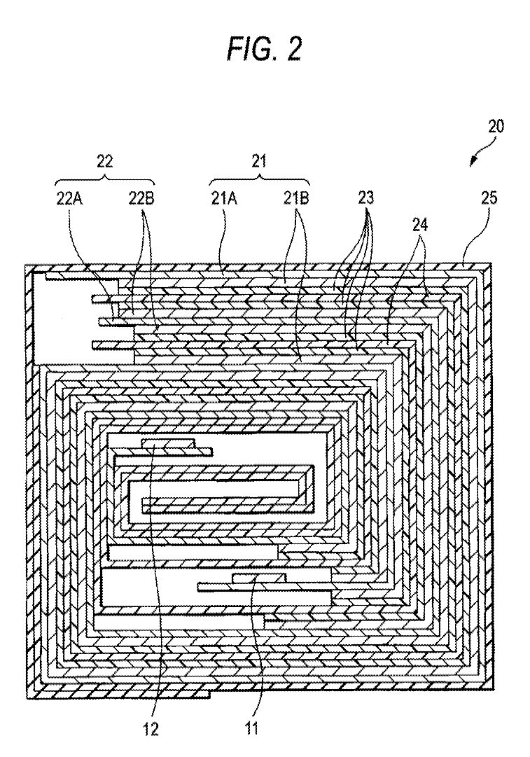

FIG. 2 is a schematic cross-sectional view showing the battery element 20 as shown in FIG. 1 along an II-II line thereof. In FIG. 2, the battery element 20 is one in which a negative electrode 21 and a positive electrode 22 are disposed opposing to each other and wound via a gel non-aqueous electrolyte layer 23 composed of a gel non-aqueous electrolyte and a separator 24, and an outermost periphery thereof is protected by a protective tape 25.

### [Negative Electrode]

Here, the negative electrode 21 has, for example, a structure in which a negative electrode mixture layer 21B is provided on one or both surfaces of a negative electrode collector 21A having a pair of opposing surfaces. The negative electrode collector 21A has a portion which is exposed without being provided with the negative electrode mixture layer 21B in one end in the longitudinal direction thereof, and the negative electrode terminal 11 is installed in this exposed portion.

The negative electrode collector 21A is constituted of a metal foil, for example, a copper foil, a nickel foil and a stainless steel foil.

The negative electrode mixture layer 21B contains, as a negative electrode active substance, any one kind or two or more kinds of a negative electrode material capable of occluding and releasing a lithium ion and metallic lithium and contains, as a binder, polyvinylidene fluoride and polyacrylonitrile or a styrene-butadiene rubber. The negative electrode mixture layer 21B may contain a conductive agent as the need arises.

Examples of the negative electrode material capable of occluding and releasing lithium include carbon materials, for example, hardly graphitized carbon, easily graphitized carbon, natural or artificial graphite, pyrolytic carbons, cokes, vitreous carbons, organic high-molecular compound burned materials, carbon fibers and active carbon. Of these, examples of the cokes include pitch coke, needle coke and petroleum coke. The organic high-molecular compound burned material as referred to herein is a material obtained through carbonization by burning a high-molecular material such as phenol resins and furan resins at an appropriate temperature, and a part thereof is classified into hardly graphitized carbon or easily graphitized carbon. Also, examples of the high-molecular material include polyacetylene and polypyrrole. Such a carbon material is preferable because a change in the crystal structure to be generated at the time of charge and discharge is very small, a high charge-discharge capacity can be obtained, and a good cycle characteristic can be obtained. In particular, graphite is preferable because its electrochemical equivalent is large, and a high energy density can be obtained. Also, hardly graphitized carbon is preferable because excellent characteristics are obtainable. Moreover, a material having a low charge-discharge potential, specifically one having a charge-discharge potential close to a lithium metal, is preferable because it is easy to realize a high energy density of the battery.

Examples of the negative electrode material capable of occluding and releasing lithium further include a material capable of occluding and releasing lithium and containing, as a constitutional element, at least one of a metal element and a semi-metal element. This is because by using such a material, a high energy density can be obtained. In particular, the joint use of such a material with the carbon material is more preferable because not only a high energy density can be obtained, but an excellent cycle characteristic can be obtained. This negative electrode material may be a single body or an alloy of a metal element or a semi-metal element. Also, the negative electrode material may have one or two or more kinds of such a phase in at least a part thereof. In an embodiment, the alloy includes alloys containing at least one metal element and at least one semi-metal element in addition to alloys composed of two or more metal elements. Also, the negative electrode material may contain a non-metal element. Examples of its texture include a solid solution, a eutectic (eutectic mixture), an intermetallic compound and one in which two or more thereof coexist.

Examples of the metal element or semi-metal element which constitutes this negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). These may be crystalline or amorphous.

Of these, ones containing, as a constitutional element, a metal element or a semi-metal element belonging to the Group 4B in the short form of the periodic table are preferable, and ones containing, as a constitutional element, at least one of silicon (Si) and tin (Sn) are especially preferable as the negative electrode material. This is because silicon (Si) and tin (Sn) have large ability for occluding and releasing lithium (Li), and a high energy density can be obtained.

Examples of alloys of tin (Sn) include alloys containing, as a second constitutional element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of silicon (Si) include alloys containing, as a second constitutional element other than silicon (Si), at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of tin (Sn) or silicon (Si) include compounds containing oxygen (O) or carbon (C), and these compounds may contain the foregoing second constitutional element in addition to tin (Sn) or silicon (Si).

Examples of the negative electrode material capable of occluding and releasing lithium further include other metal compounds and high-molecular materials. Examples of other metal compounds include oxides, for example, MnO₂, V₂O₅ and V₆O₁₃, sulfides, for example, NiS and MoS and lithium nitrides, for example, LiN₃; and examples of high-molecular materials include polyacetylene, polyaniline and polypyrrole.

Also, as a material capable of alloying lithium, various kinds of metals can be used. Tin (Sn), cobalt (Co), indium (In), aluminum (Al), silicon (Si) and alloys thereof are frequently used. In case of using metallic lithium, a powder may be formed into a coating by using a binder.

Also, as described previously, for example, binders containing at least polyvinylidene fluoride and polyacrylonitrile and binders containing at least polyvinylidene fluoride and a styrene-butadiene rubber are useful as the binder.

As the foregoing polyvinylidene fluoride, for example, polyvinylidene fluoride having an intrinsic viscosity of from 1.5 to 10.0 dl/g is preferable, but it should not be construed that the polyvinylidene fluoride is limited thereto. Also, as the foregoing polyacrylonitrile, for example, polyacrylonitrile having a functional group (for example, an alcoholic hydroxyl group, a carboxyl group and a nitrile group) in a molecule thereof is preferable, but it should not be construed that the polyacrylonitrile is limited thereto.

Though the total content of the foregoing polyvinylidene fluoride and polyacrylonitrile is not particularly limited, it is preferably from 2.0 to 6.5%, and more preferably from 2.5 to 5.0% on the basis of the whole content of the negative electrode mixture. Though a ratio of polyvinylidene fluoride and polyacrylonitrile (polyvinylidene fluoride to polyacrylonitrile) is not particularly limited, it is preferably from 5/95 to 95/5, and more preferably from 15/85 to 85/15 in terms of a weight ratio.

On the other hand, though the total content of polyvinylidene fluoride and the styrene-butadiene rubber is not particularly limited, it is preferably from 2.5 to 6.5%, and more preferably from 2.5 to 5.0% on the basis of the whole content of the negative electrode mixture. Though a ratio of polyvinylidene fluoride and the styrene-butadiene rubber (polyvinylidene fluoride to styrene-butadiene rubber) is not particularly limited, it is preferably from 90/10 to 30/70 in terms of a weight ratio.

Polytetrafluoroethylene, polyvinylidene trifluoride, etc. may be mixed and used, too.

Furthermore, a carbon material, for example, carbon black and graphite or the like is used as a conductive agent.

### [Positive Electrode]

On the other hand, likewise the negative electrode 21, the positive electrode 22 has, for example, a structure in which a positive electrode mixture layer 22B is coated on one or both surfaces of a positive electrode collector 22A having a pair of opposing surfaces. The positive electrode collector 22A has a portion which is exposed without being provided with the positive electrode mixture layer 22B in one end in the longitudinal direction thereof, and the positive electrode terminal 12 is installed in this exposed portion.

The positive electrode collector 22A is constituted of a metal foil, for example, an aluminum foil.

The positive electrode mixture layer 22B contains, as a positive electrode active substance, a positive electrode material capable of occluding and releasing a lithium ion. The positive electrode mixture layer 22B may contain a conductive agent and a binder as the need arises.

Here, the positive electrode active substance, the conductive agent and the binder may be uniformly dispersed, and a mixing ratio thereof does not material.

The positive electrode material capable of occluding and releasing lithium to be used as the positive electrode substance is chosen according to the kind of a desired battery, and suitable examples thereof include lithium-containing compounds, for example, lithium oxide, lithium phosphorus oxide, lithium sulfide and lithium-containing intercalation compounds. A mixture of two or more kinds thereof may be used. In order to increase the energy density, a lithium-containing compound containing lithium, a transition metal element and oxygen (O) is preferable. Of theses, one containing, as the transition metal element, at least one member selected from the group consisting of cobalt (Co), nickel (Ni), manganese (Mn) and iron (Fe) is more preferable. Examples of such a lithium-containing compound include lithium composite oxides having a layered rock salt structure as shown in the following (1) to (3); lithium composite oxides having a spinel type structure as shown in the following (4); and lithium composite phosphates having an olivine type structure as shown in the following (5). Specific examples thereof include LiNi_{0.50}Co_{0.20}Mn_{0.30}O₂, LiₐCoO₂ (a≅1), Li_{b}NiO₂ (b≅1), Li_{c1}Ni_{c2}CO_{1-c2}O₂ (c1≅1, 0<c2<1), Li_{d}Mn₂O₄ (d≅1) and LiₑFₑPO₄ (e≅1).

Li_{f}Mn_{(1-g-h)}Ni_{g}M1ₕO₍₂₋ⱼ₎Fₖ (1)

In the following (1), M1 represents at least one member selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr) and tungsten (W); and f, g, h, j and k are each a value satisfied with 0.8≦f≦1.2, 0<g<0.5, 0≦h≦0.5, (g+h)<1, −0.1≦j≦0.2, and 0≦k≦0.1. The composition of lithium varies with the state of charge and discharge; and the value of f represents a value in the complete discharge state.

LiₘNi₍₁₋ₙ₎M2ₙO₍₂₋ₚ₎F_{q} (2)

In the following (2), M2 represents at least one member selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W); and m, n, p and q are each a value satisfied with 0.8≦m≦1.2, 0.005≦n≦0.5, −0.1≦p≦0.2, and 0≦q≦0.1. The composition of lithium varies with the state of charge and discharge; and the value of m represents a value in the complete discharge state.

LiᵣCo₍₁₋ₛ₎M3ₛO₍₂₋ₜ₎Fᵤ (3)

In the following (3), M3 represents at least one member selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W); and, s, t and u are each a value satisfied with 0.8≦r≦1.2, 0≦s≦0.5, −0.1≦t≦0.2, and 0≦u≦0.1. The composition of lithium varies with the state of charge and discharge; and the value of r represents a value in the complete discharge state.

LiᵥMn_{2-w}M4_{w}OₓF_{y} (4)

In the following (4), M4 represents at least one member selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W); and v, w, x and y are each a value satisfied with 0.9≦v≦1.1, 0≦w≦0.6, 3.7≦x≦4.1, and 0≦y≦0.1. The composition of lithium varies with the state of charge and discharge; and the value of v represents a value in the complete discharge state.

Li_{z}M5PO₄ (5)

In the following (5), M5 represents at least one member selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr); and z is a value satisfied with 0.9≦z≦1.1. The composition of lithium varies with the state of charge and discharge; and the value of z represents a value in the complete discharge state.

In addition to the foregoing compounds, examples of the positive electrode material capable of occluding and releasing lithium include lithium-free inorganic compounds, for example, MnO₂, V₂O₅, V₆O₁₃, NiS and MoS.

Also, examples of the conductive agent which is useful include carbon materials, for example, carbon black and graphite. Furthermore, examples of the binder which is useful include polyvinylidene fluoride, polytetrafluoroethylene and polyvinylidene trifluoride.

### [Gel Non-Aqueous Electrolyte Layer]

The gel non-aqueous electrolyte which forms the gel non-aqueous electrolyte layer 23 is one prepared by gelation of a non-aqueous electrolytic liquid with a matrix polymer.

In the gel non-aqueous electrolyte, the non-aqueous electrolytic liquid is impregnated with or supported by the matrix polymer. By swelling or gelation or non-fluidization of such a matrix polymer, it is possible to effectively suppress the occurrence of liquid leakage of the non-aqueous electrolyte in the obtained battery.

As the non-aqueous electrolytic liquid, ones which are generally used in lithium ion secondary batteries are useful. As such a non-aqueous electrolytic liquid, ones obtained by dissolving an electrolyte salt in a non-aqueous solvent are useful.

Specific examples of the non-aqueous solvent which can be used include cyclic carbonic esters such as ethylene carbonate and propylene carbonate. It is preferable to use either one of ethylene carbonate and propylene carbonate, and it is especially preferable to use a mixture of ethylene carbonate and propylene carbonate. This is because the cycle characteristic can be enhanced.

In addition to the foregoing cyclic carbonic ester, it is preferable to use a mixture thereof with a chain carbonic ester such as diethyl carbonate, dimethyl carbonate, ethylmethyl carbonate and methylisopropyl carbonate as the non-aqueous solvent. This is because high ionic conductivity can be obtained.

Moreover, it is preferable that the non-aqueous solvent further contains 2,4-difluoroanisole or vinylene carbonate. This is because 2,4-difluoroanisole is able to enhance the discharge capacity; and vinylene carbonate is able to enhance the cycle characteristic. Accordingly, the use of a mixture of these compounds is preferable because the discharge capacity and the cycle characteristic can be enhanced.

Besides, examples of the non-aqueous solvent include butylene carbonate, γ-butyrolactone, γ-valerolactone, 1,2-dimethoxyethane, tetrahydrofuran, 2-methyltetrahydrofuran, 1,3-dioxolan, 4-methyl-1,3-dioxolan, methyl acetate, methyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, N,N-dimethylimidazolidinone, nitromethane, nitroethane, sulfolane, dimethyl sulfoxide and trimethyl phosphate.

A compound obtained by substituting at least a part of hydrogen of such a non-aqueous solvent with a halogen such as fluorine may be sometimes preferable because reversibility of the electrode reaction can be enhanced depending upon the kind of an electrode to be combined.

Examples of the electrolyte salt include lithium salts, and these lithium salts may be used singly or in admixture of two or more kinds thereof. Examples of the lithium salt include LiPF₆, LiBF₄, LiAsF₆, LiClO₃, LiClO₄, LiNO₃, LiB(C₆H₅)₄, LiCH₃SO₃, LiCF₃SO₃, LiN(CF₃SO₂)₂, LiN(C₂F₅SO₂)₂, LiC(SO₂CF₃)₃, LiAlCl₄, LiSiF₆, lithium difluoro[oxolato-O,O′]borate, lithium bisoxolatoborate, LiBr, LiCl and LiI.

A concentration at which the lithium salt is dissolved is preferably in the range of 0.4 moles/kg or more and not more than 2.0 moles/kg relative to the foregoing non-aqueous solvent.

From the viewpoint of oxidation stability, it is desirable to use LiPF₆ or LiBF₄. Above all, LiPF₆ is preferable because not only high ionic conductivity can be obtained, but the cycle characteristic can be enhanced.

The gel non-aqueous electrolyte is used upon gelation of a non-aqueous electrolytic liquid with a matrix polymer. The matrix polymer may be one which is compatible with the non-aqueous electrolytic liquid having the foregoing electrolyte salt dissolved in the foregoing non-aqueous solvent and can be gelated. Examples of such a matrix polymer include fluorocarbon based high-molecular compounds such as polyvinylidene fluoride and copolymers with vinylidene fluoride; ether based high-molecular compounds such as polyethylene oxide and polyethylene oxide-containing crosslinked materials; and polymers containing, as a repeating unit, polypropylene oxide, polyacrylonitrile or polymethacrylonitrile.

Specific examples thereof include a copolymer of polyvinylidene fluoride and hexafluoropropylene, a copolymer of polyvinylidene fluoride, hexafluoropropylene and monochlorotrifluoroethylene, and a copolymer of polyvinylidene fluoride, hexafluoropropylene and monomethyl maleate.

These polymers may be used singly or in admixture of two or more kinds thereof.

Of these, from the viewpoint of oxidation-reduction stability, fluorocarbon based high-molecular compounds are especially desirable. For example, polyvinylidene fluorine and a copolymer in which hexafluoropropylene is introduced in a proportion of not more than 75% into vinylidene fluoride can be used. Such a polymer has a number average molecular weight in the range of from 5.0×10⁵ to 7.0×10⁵ (from 500,000 to 700,000) or a weight average molecular weight in the range of from 2.1×10⁵ to 3.1×10⁵ (from 210,000 to 310,000) and has an intrinsic viscosity in the range of from 1.7 (dl/g) to 2.1 (dig).

### [Separator]

Also, the separator 24 is constituted of an insulating thin membrane having large ion permeability and prescribed mechanical strength, for example, a porous membrane made of a polyolefin based organic resin, for example, polypropylene and polyethylene, or a porous membrane made of an inorganic material, for example, a ceramic-made non-woven fabric and may also have a structure in which two or more kinds of such a porous membrane are laminated. In particular, one containing a polyolefin based porous membrane is favorable because it is excellent in separation properties between the negative electrode 21 and the positive electrode 22, and an internal short circuit and a lowering in an open circuit voltage can be much more reduced.

Next, one example of the manufacturing method of the foregoing gel electrolyte secondary battery is described.

The foregoing laminate type secondary battery can be manufactured in the following manner.

First of all, the negative electrode 21 is prepared. For example, in case of using a granular negative electrode active substance, a negative electrode active substance and the foregoing binder and optionally, a conductive agent are mixed to prepare a negative electrode mixture, which is then dispersed in a dispersant such as N-methyl-2-pyrrolidone to prepare a negative electrode mixture slurry.

Next, this negative electrode mixture slurry is coated on the negative electrode collector 21A and dried, and then compression molded to form the negative electrode mixture layer 21B.

Also, the positive electrode 22 is prepared. For example, in case of using a granular positive electrode active substance, a positive electrode active substance and optionally, a conductive agent and a binder are mixed to prepare a positive electrode mixture, which is then dispersed in a dispersant such as N-methyl-2-pyrrolidone to prepare a positive electrode mixture slurry. Thereafter, this positive electrode mixture slurry is coated on the positive electrode collector 22A and dried, and then compression molded to form the positive electrode mixture layer 22B.

Next, the negative electrode terminal 11 is installed in the negative electrode 21, and the positive electrode terminal 12 is also installed in the positive electrode 22. At that time, the protective tape 25 may be stuck on a welded part of the negative electrode terminal 11 or the positive electrode terminal 12 and its back surface, or on the collector of an interface portion between the mixture-coated portion and the collector-exposed portion.

Next, the gel non-aqueous electrolyte layer 23 is formed one or both surfaces of the thus obtained negative electrode 21. For example, an electrolyte salt (for example, lithium hexafluorophosphate), a non-aqueous solvent (for example, ethylene carbonate and propylene carbonate) and a matrix polymer (for example, polyvinylidene fluoride) are mixed and dissolved together with a diluting solvent (for example, dimethyl carbonate (DMC)) to prepare a sol non-aqueous electrolyte. This sol non-aqueous electrolyte is coated on the negative electrode 21, and the diluting solvent is volatilized to form the gel non-aqueous electrolyte layer 23 composed of a gel non-aqueous electrolyte.

Furthermore, the gel non-aqueous electrolyte layer 23 is formed one or both surfaces of the thus obtained positive electrode 22. For example, an electrolyte salt (for example, lithium hexafluorophosphate), a non-aqueous solvent (for example, ethylene carbonate and propylene carbonate) and a matrix polymer (for example, polyvinylidene fluoride) are mixed and dissolved together with a diluting solvent (for example, dimethyl carbonate (DMC)) to prepare a sol non-aqueous electrolyte. This sol non-aqueous electrolyte is coated on the positive electrode 22, and the diluting solvent is volatilized to form the gel non-aqueous electrolyte layer 23 composed of a gel non-aqueous electrolyte.

Thereafter, the separator 24, the positive electrode 22 having the gel non-aqueous electrolyte layer 23 formed thereon, the separator 24 and the negative electrode 21 having the gel non-aqueous electrolyte layer 23 formed thereon are successively laminated and wound, and the protective tape 25 is bonded to the outermost periphery to form the battery element 20. Furthermore, this battery element 20 is packed by the exterior member 30. There is thus completed the laminate type secondary battery as shown in FIGS. 1 and 2.

This gel electrolyte secondary battery may also be manufactured in the following manner.

For example, the completed battery element is not packed by an exterior member, but gel non-aqueous electrolyte layer 23 may be formed by coating a monomer or polymer of a matrix polymer such as the foregoing polyvinylidene fluoride on the negative electrode 21 and the positive electrode 22 or the separator 24 and winding to prepare a wound electrode body, containing the wound electrode body in the inside of the exterior member 30 and then pouring the foregoing non-aqueous electrolytic liquid thereinto. However, what the monomer is polymerized in the inside of the exterior member 30 is preferable because joining properties between the gel non-aqueous electrolyte layer 23 and the separator 24 are enhanced, whereby the internal resistance can be reduced. Also, what the non-aqueous electrolytic liquid is poured into the inside of the exterior member 30 to form a gel non-aqueous electrolyte is preferable because it can be simply manufactured in a small number of processes.

In the above-described secondary battery, when charge is carried out, a lithium ion is released from the positive electrode mixture layer 22B and occluded in the negative electrode mixture layer 21B via the gel non-aqueous electrolyte layer 23. When discharge is carried out, a lithium ion is released from the negative electrode mixture layer 21B and occluded in the positive electrode mixture layer 22B via the gel non-aqueous electrolyte layer 23.

### EXAMPLES

An embodiment according is hereunder described in more detail with reference to the following Examples and Comparative Examples. Concretely, the laminate type secondary batteries as shown in FIGS. 1 and 2 were prepared by carrying out the operations described in each of these Examples and Comparative Examples, and performances thereof were evaluated.

### Example 1-1

### Preparation of Negative Electrode

First of all, 99.0 parts by weight of natural graphite as a negative electrode active substance and 0.050 parts by weight of polyvinylidene fluoride (PVdF) (intrinsic viscosity: about 2 dl/g) and 0.950 parts by weight of polyacrylonitrile (PAN) (carboxyl group-containing PAN based resin) as a binder were uniformly mixed, and N-methyl-2-pyrrolidone (NMP) was added to obtain a negative electrode mixture slurry.

Next, the obtained negative electrode mixture slurry was uniformly coated on both surfaces of a negative electrode collector made of a copper foil having a thickness of 12 μm, dried and then compression molded by a roll press to form a negative electrode mixture layer (thickness: 100 μm, binder content: 1%). The thus formed negative electrode mixture layer was cut out in a width of 44 mm to prepare a negative electrode. Thereafter, a negative electrode terminal made of nickel was installed in the negative electrode.

### <Preparation of Positive Electrode>

Next, 90 parts by weight of lithium cobaltate (LiCoO₂) as a positive electrode active substance, 4 parts by weight of carbon black as a conductive agent and 6 parts by weight of polyvinylidene fluoride (PVdF) (intrinsic viscosity: about 2 dl/g) as a binder were uniformly mixed, and NMP was added to obtain a positive electrode mixture slurry. Next, the obtained positive electrode mixture slurry was uniformly coated on both surfaces of a positive electrode collector made of an aluminum foil having a thickness of 15 μm, dried and then compression molded by a roll press to form a positive electrode mixture layer (thickness: 105 μm). The thus formed positive electrode mixture layer was cut out in a width of 42.5 mm to prepare a positive electrode. Thereafter, a positive electrode terminal made of aluminum was installed in the positive electrode.

### <Preparation of Gel Non-Aqueous Electrolyte>

1 mole/kg of lithium hexafluorophosphate (LiPF₆) as an electrolyte salt was dissolved in a non-aqueous solvent obtained by mixing ethylene carbonate (EC) and propylene carbonate (PC) in a proportion of 4/6 (weight ratio) to prepare an electrolytic liquid.

A copolymer of hexafluoropropylene and polyvinylidene fluoride (hexafluoropropylene content: 7%) as a matrix polymer was mixed in a proportion of the matrix polymer to the electrolytic liquid of 1/6 (weight ratio), and a sol non-aqueous electrolyte was prepared by using dimethyl carbonate (DMC) as a solvent.

The obtained sol non-aqueous electrolyte was uniformly coated on both surfaces of each of the obtained negative electrode and positive electrode, and the solvent was volatilized to form a gel non-aqueous electrolyte layer (thickness: 5 μm) on each of the negative electrode and the positive electrode.

### <Preparation of Gel Electrolyte Battery>

The negative electrode and the positive electrode each having this gel non-aqueous electrolyte layer formed thereon were laminated via a porous separator made of polyethylene having a thickness of 12 μm and wound to prepare a battery element, which was then packed by an aluminum laminate film as an exterior member to obtain a gel electrolyte secondary battery of the present Example.

An open circuit voltage in a completely filled state (fully charged state in the use upon being charged by a standard charger) per one pair of the positive electrode and the negative electrode was adjusted at 4.20 V. Also, the standard charge as referred to herein means constant-current constant-voltage charge to be carried out at 23° C. at a prescribed voltage and a current of 1 C until the total sum of charging time reaches 2.5 hours. Furthermore, 1 C as referred to herein means a current value at which a rated capacity of the battery is discharged for one hour; and 0.2 C, 0.5 C and 2 C as referred to herein mean a current value at which a rated capacity of the battery is discharged for 5 hours, 2 hours and 30 minutes, respectively.

### Examples 1-2 to 1-11 and Comparative Examples 1-1 to 1-2

Gel electrolyte secondary batteries of the respective Examples were obtained by following the same operations as in Example 1-1, except for changing the blending proportion of PVdF to PAN in the binder of the negative electrode as shown in Table 1. Specifications of the foregoing respective Examples are shown in Table 1.

TABLE 1

| | Binder (1.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 1-1 | 5/95 | 0.050 | 0.950 | 840 | 76 | 69 | 0.56 |
| Example 1-2 | 10/90 | 0.100 | 0.900 | 840 | 76 | 69 | 0.56 |
| Example 1-3 | 15/85 | 0.150 | 0.850 | 840 | 76 | 69 | 0.56 |
| Example 1-4 | 20/80 | 0.200 | 0.800 | 840 | 76 | 69 | 0.56 |
| Example 1-5 | 30/70 | 0.300 | 0.700 | 840 | 76 | 69 | 0.58 |
| Example 1-6 | 50/50 | 0.500 | 0.500 | 840 | 76 | 69 | 0.58 |
| Example 1-7 | 70/30 | 0.700 | 0.300 | 840 | 77 | 70 | 0.59 |
| Example 1-8 | 80/20 | 0.800 | 0.200 | 840 | 77 | 70 | 0.59 |
| Example 1-9 | 85/15 | 0.850 | 0.150 | 840 | 77 | 70 | 0.60 |
| Example 1-10 | 90/10 | 0.900 | 0.100 | 840 | 77 | 70 | 0.60 |
| Example 1-11 | 95/5 | 0.950 | 0.050 | 840 | 77 | 70 | 0.60 |
| Comparative | 0/100 | 0.000 | 1.000 | 840 | 76 | 57 | 0.55 |
| Example 1-1 | | | | | | | |
| Comparative | 100/0 | 1.000 | 0.000 | 840 | 77 | 70 | 0.63 |
| Example 1-2 | | | | | | | |

### Example 2-1

A gel electrolyte secondary battery of the present Example was obtained by following the same operations as in Example 1-1, except that a negative electrode mixture slurry obtained by uniformly mixing 98.0 parts by weight of natural graphite as a negative electrode active substance and 0.100 parts by weight of PVdF and 1.900 parts by weight of PAN as a binder and adding NMP was used in the preparation of a negative electrode.

### Examples 2-2 to 2-11 and Comparative Examples 2-1 to 2-2

Gel electrolyte secondary batteries of the respective Examples were obtained by following the same operations as in Example 2-1, except for changing the blending proportion of PVdF to PAN in the binder of the negative electrode as shown in Table 2. Specifications of the foregoing respective Examples are shown in Table 2.

TABLE 2

| | Binder (2.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 2-1 | 5/95 | 0.100 | 1.900 | 832 | 94 | 95 | 0.31 |
| Example 2-2 | 10/90 | 0.200 | 1.800 | 832 | 94 | 95 | 0.31 |
| Example 2-3 | 15/85 | 0.300 | 1.700 | 832 | 94 | 95 | 0.31 |
| Example 2-4 | 20/80 | 0.400 | 1.600 | 832 | 94 | 95 | 0.31 |
| Example 2-5 | 30/70 | 0.600 | 1.400 | 832 | 94 | 95 | 0.32 |
| Example 2-6 | 50/50 | 1.000 | 1.000 | 832 | 94 | 95 | 0.35 |
| Example 2-7 | 70/30 | 1.400 | 0.600 | 832 | 95 | 96 | 0.36 |
| Example 2-8 | 80/20 | 1.600 | 0.400 | 832 | 95 | 96 | 0.36 |
| Example 2-9 | 85/15 | 1.700 | 0.300 | 832 | 95 | 96 | 0.36 |
| Example 2-10 | 90/10 | 1.800 | 0.200 | 832 | 95 | 96 | 0.37 |
| Example 2-11 | 95/5 | 1.900 | 0.100 | 832 | 95 | 96 | 0.37 |
| Comparative | 0/100 | 0.000 | 2.000 | 832 | 94 | 72 | 0.51 |
| Example 2-1 | | | | | | | |
| Comparative | 100/0 | 2.000 | 0.000 | 832 | 95 | 90 | 0.53 |
| Example 2-2 | | | | | | | |

### Example 3-1

A gel electrolyte secondary battery of the present Example was obtained by following the same operations as in Example 1-1, except that a negative electrode mixture slurry obtained by uniformly mixing 96.5 parts by weight of natural graphite as a negative electrode active substance and 0.175 parts by weight of PVdF and 3.325 parts by weight of PAN as a binder and adding NMP was used in the preparation of a negative electrode.

### Examples 3-2 to 3-11 and Comparative Examples 3-1 to 3-2

Gel electrolyte secondary batteries of the respective Examples were obtained by following the same operations as in Example 3-1, except for changing the blending proportion of PVdF to PAN in the binder of the negative electrode as shown in Table 3. Specifications of the foregoing respective Examples are shown in Table 3.

TABLE 3

| | Binder (3.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 3-1 | 5/95 | 0.175 | 3.325 | 818 | 94 | 95 | 0.31 |
| Example 3-2 | 10/90 | 0.350 | 3.150 | 818 | 94 | 95 | 0.31 |
| Example 3-3 | 15/85 | 0.525 | 2.975 | 818 | 94 | 95 | 0.31 |
| Example 3-4 | 20/80 | 0.700 | 2.800 | 818 | 94 | 95 | 0.31 |
| Example 3-5 | 30/70 | 1.050 | 2.450 | 818 | 94 | 95 | 0.32 |
| Example 3-6 | 50/50 | 1.750 | 1.750 | 818 | 94 | 95 | 0.36 |
| Example 3-7 | 70/30 | 2.450 | 1.050 | 818 | 95 | 96 | 0.37 |
| Example 3-8 | 80/20 | 2.800 | 0.700 | 818 | 95 | 96 | 0.37 |
| Example 3-9 | 85/15 | 2.975 | 0.525 | 818 | 95 | 96 | 0.37 |
| Example 3-10 | 90/10 | 3.150 | 0.350 | 818 | 95 | 96 | 0.38 |
| Example 3-11 | 95/5 | 3.325 | 0.175 | 818 | 95 | 96 | 0.38 |
| Comparative | 0/100 | 0.000 | 3.500 | 818 | 94 | 72 | 0.52 |
| Example 3-1 | | | | | | | |
| Comparative | 100/0 | 3.500 | 0.000 | 818 | 95 | 90 | 0.53 |
| Example 3-2 | | | | | | | |

### Example 4-1

A gel electrolyte secondary battery of the present Example was obtained by following the same operations as in Example 1-1, except that a negative electrode mixture slurry obtained by uniformly mixing 95.0 parts by weight of natural graphite as a negative electrode active substance and 0.250 parts by weight of PVdF and 4.750 parts by weight of PAN as a binder and adding NMP was used in the preparation of a negative electrode.

### Examples 4-2 to 4-11 and Comparative Examples 4-1 to 4-2

Gel electrolyte secondary batteries of the respective Examples were obtained by following the same operations as in Example 4-1, except for changing the blending proportion of PVdF to PAN in the binder of the negative electrode as shown in Table 4. Specifications of the foregoing respective Examples are shown in Table 4.

TABLE 4

| | Binder (5.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 4-1 | 5/95 | 0.250 | 4.750 | 803 | 94 | 94 | 0.34 |
| Example 4-2 | 10/90 | 0.500 | 4.500 | 803 | 94 | 94 | 0.34 |
| Example 4-3 | 15/85 | 0.750 | 4.250 | 803 | 94 | 94 | 0.34 |
| Example 4-4 | 20/80 | 1.000 | 4.000 | 803 | 94 | 94 | 0.34 |
| Example 4-5 | 30/70 | 1.500 | 3.500 | 803 | 94 | 94 | 0.35 |
| Example 4-6 | 50/50 | 2.500 | 2.500 | 803 | 94 | 94 | 0.37 |
| Example 4-7 | 70/30 | 3.500 | 1.500 | 803 | 95 | 95 | 0.39 |
| Example 4-8 | 80/20 | 4.000 | 1.000 | 803 | 95 | 95 | 0.39 |
| Example 4-9 | 85/15 | 4.250 | 0.750 | 803 | 95 | 95 | 0.39 |
| Example 4-10 | 90/10 | 4.500 | 0.500 | 803 | 95 | 95 | 0.40 |
| Example 4-11 | 95/5 | 4.750 | 0.250 | 803 | 95 | 95 | 0.40 |
| Comparative | 0/100 | 0.000 | 5.000 | 803 | 94 | 71 | 0.53 |
| Example 4-1 | | | | | | | |
| Comparative | 100/0 | 5.000 | 0.000 | 803 | 95 | 90 | 0.56 |
| Example 4-2 | | | | | | | |

### Example 5-1

A gel electrolyte secondary battery of the present Example was obtained by following the same operations as in Example 1-1, except that a negative electrode mixture slurry obtained by uniformly mixing 93.5 parts by weight of natural graphite as a negative electrode active substance and 0.325 parts by weight of PVdF and 6.175 parts by weight of PAN as a binder and adding NMP was used in the preparation of a negative electrode.

### Examples 5-2 to 5-11 and Comparative Examples 5-1 to 5-2

Gel electrolyte secondary batteries of the respective Examples were obtained by following the same operations as in Example 5-1, except for changing the blending proportion of PVdF to PAN in the binder of the negative electrode as shown in Table 5. Specifications of the foregoing respective Examples are shown in Table 5.

TABLE 5

| | Binder (6.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 5-1 | 5/95 | 0.325 | 6.175 | 791 | 93 | 94 | 0.36 |
| Example 5-2 | 10/90 | 0.650 | 5.850 | 791 | 93 | 94 | 0.36 |
| Example 5-3 | 15/85 | 0.975 | 5.525 | 791 | 93 | 94 | 0.36 |
| Example 5-4 | 20/80 | 1.300 | 5.200 | 791 | 93 | 94 | 0.36 |
| Example 5-5 | 30/70 | 1.950 | 4.550 | 791 | 93 | 94 | 0.37 |
| Example 5-6 | 50/50 | 3.250 | 3.250 | 791 | 93 | 94 | 0.41 |
| Example 5-7 | 70/30 | 4.550 | 1.950 | 791 | 94 | 95 | 0.43 |
| Example 5-8 | 80/20 | 5.200 | 1.300 | 791 | 94 | 95 | 0.43 |
| Example 5-9 | 85/15 | 5.525 | 0.975 | 791 | 94 | 95 | 0.43 |
| Example 5-10 | 90/10 | 5.850 | 0.650 | 791 | 94 | 95 | 0.47 |
| Example 5-11 | 95/5 | 6.175 | 0.325 | 791 | 94 | 95 | 0.47 |
| Comparative | 0/100 | 0.000 | 6.500 | 791 | 93 | 70 | 0.54 |
| Example 5-1 | | | | | | | |
| Comparative | 100/0 | 6.500 | 0.000 | 791 | 94 | 90 | 0.62 |
| Example 5-2 | | | | | | | |

### Example 6-1

A gel electrolyte secondary battery of the present Example was obtained by following the same operations as in Example 1-1, except that a negative electrode mixture slurry obtained by uniformly mixing 92.0 parts by weight of natural graphite as a negative electrode active substance and 0.400 parts by weight of PVdF and 7.600 parts by weight of PAN as a binder and adding NMP was used in the preparation of a negative electrode.

### Examples 6-2 to 6-11 and Comparative Examples 6-1 to 6-2

Gel electrolyte secondary batteries of the respective Examples were obtained by following the same operations as in Example 6-1, except for changing the blending proportion of PVdF to PAN in the binder of the negative electrode as shown in Table 6. Specifications of the foregoing respective Examples are shown in Table 6.

TABLE 6

| | Binder (8.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 6-1 | 5/95 | 0.400 | 7.600 | 779 | 75 | 70 | 0.59 |
| Example 6-2 | 10/90 | 0.800 | 7.200 | 779 | 75 | 70 | 0.59 |
| Example 6-3 | 15/85 | 1.200 | 6.800 | 779 | 75 | 70 | 0.59 |
| Example 6-4 | 20/80 | 1.600 | 6.400 | 779 | 75 | 70 | 0.59 |
| Example 6-5 | 30/70 | 2.400 | 5.600 | 779 | 75 | 70 | 0.61 |
| Example 6-6 | 50/50 | 4.000 | 4.000 | 779 | 75 | 70 | 0.62 |
| Example 6-7 | 70/30 | 5.600 | 2.400 | 779 | 76 | 71 | 0.63 |
| Example 6-8 | 80/20 | 6.400 | 1.600 | 779 | 76 | 71 | 0.63 |
| Example 6-9 | 85/15 | 6.800 | 1.200 | 779 | 76 | 71 | 0.63 |
| Example 6-10 | 90/10 | 7.200 | 0.800 | 779 | 76 | 71 | 0.64 |
| Example 6-11 | 95/5 | 7.600 | 0.400 | 779 | 76 | 71 | 0.64 |
| Comparative | 0/100 | 0.000 | 8.000 | 779 | 75 | 60 | 0.58 |
| Example 6-1 | | | | | | | |
| Comparative | 100/0 | 8.000 | 0.000 | 779 | 76 | 64 | 0.69 |
| Example 6-2 | | | | | | | |

### Example 7-1

A gel electrolyte secondary battery of the present Example was obtained by following the same operations as in Example 1-1, except that a negative electrode mixture slurry obtained by uniformly mixing 99.0 parts by weight of artificial graphite as a negative electrode active substance and 0.050 parts by weight of PVdF and 0.950 parts by weight of PAN as a binder and adding NMP was used in the preparation of a negative electrode.

### Examples 7-2 to 7-11 and Comparative Examples 7-1 to 7-2

Gel electrolyte secondary batteries of the respective Examples were obtained by following the same operations as in Example 7-1, except for changing the blending proportion of PVdF to PAN in the binder of the negative electrode as shown in Table 7. Specifications of the foregoing respective Examples are shown in Table 7.

TABLE 7

| | Binder (1.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 7-1 | 5/95 | 0.050 | 0.950 | 830 | 76 | 70 | 0.52 |
| Example 7-2 | 10/90 | 0.100 | 0.900 | 830 | 76 | 70 | 0.52 |
| Example 7-3 | 15/85 | 0.150 | 0.850 | 830 | 76 | 70 | 0.52 |
| Example 7-4 | 20/80 | 0.200 | 0.800 | 830 | 76 | 70 | 0.52 |
| Example 7-5 | 30/70 | 0.300 | 0.700 | 830 | 76 | 70 | 0.53 |
| Example 7-6 | 50/50 | 0.500 | 0.500 | 830 | 76 | 70 | 0.54 |
| Example 7-7 | 70/30 | 0.700 | 0.300 | 830 | 77 | 71 | 0.55 |
| Example 7-8 | 80/20 | 0.800 | 0.200 | 830 | 77 | 71 | 0.55 |
| Example 7-9 | 85/15 | 0.850 | 0.150 | 830 | 77 | 71 | 0.55 |
| Example 7-10 | 90/10 | 0.900 | 0.100 | 830 | 77 | 71 | 0.55 |
| Example 7-11 | 95/5 | 0.950 | 0.050 | 830 | 77 | 71 | 0.55 |
| Comparative | 0/100 | 0.000 | 1.000 | 830 | 76 | 60 | 0.51 |
| Example 7-1 | | | | | | | |
| Comparative | 100/0 | 1.000 | 0.000 | 830 | 77 | 65 | 0.56 |
| Example 7-2 | | | | | | | |

### Example 8-1

A gel electrolyte secondary battery of the present Example was obtained by following the same operations as in Example 1-1, except that a negative electrode mixture slurry obtained by uniformly mixing 98.0 parts by weight of artificial graphite as a negative electrode active substance and 0.100 parts by weight of PVdF and 1.900 parts by weight of PAN as a binder and adding NMP was used in the preparation of a negative electrode.

### Examples 8-2 to 8-11 and Comparative Examples 8-1 to 8-2

Gel electrolyte secondary batteries of the respective Examples were obtained by following the same operations as in Example 8-1, except for changing the blending proportion of PVdF to PAN in the binder of the negative electrode as shown in Table 8. Specifications of the foregoing respective Examples are shown in Table 8.

TABLE 8

| | Binder (2.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 8-1 | 5/95 | 0.100 | 1.900 | 822 | 94 | 96 | 0.31 |
| Example 8-2 | 10/90 | 0.200 | 1.800 | 822 | 94 | 96 | 0.31 |
| Example 8-3 | 15/85 | 0.300 | 1.700 | 822 | 94 | 96 | 0.31 |
| Example 8-4 | 20/80 | 0.400 | 1.600 | 822 | 94 | 96 | 0.31 |
| Example 8-5 | 30/70 | 0.600 | 1.400 | 822 | 94 | 96 | 0.32 |
| Example 8-6 | 50/50 | 1.000 | 1.000 | 822 | 94 | 96 | 0.35 |
| Example 8-7 | 70/30 | 1.400 | 0.600 | 822 | 95 | 97 | 0.36 |
| Example 8-8 | 80/20 | 1.600 | 0.400 | 822 | 95 | 97 | 0.37 |
| Example 8-9 | 85/15 | 1.700 | 0.300 | 822 | 95 | 97 | 0.37 |
| Example 8-10 | 90/10 | 1.800 | 0.200 | 822 | 95 | 97 | 0.38 |
| Example 8-11 | 95/5 | 1.900 | 0.100 | 822 | 95 | 97 | 0.39 |
| Comparative | 0/100 | 0.000 | 2.000 | 822 | 94 | 72 | 0.51 |
| Example 8-1 | | | | | | | |
| Comparative | 100/0 | 2.000 | 0.000 | 822 | 95 | 91 | 0.53 |
| Example 8-2 | | | | | | | |

### Example 9-1

A gel electrolyte secondary battery of the present Example was obtained by following the same operations as in Example 1-1, except that a negative electrode mixture slurry obtained by uniformly mixing 97.5 parts by weight of artificial graphite as a negative electrode active substance and 0.125 parts by weight of PVdF and 2.375 parts by weight of PAN as a binder and adding NMP was used in the preparation of a negative electrode.

### Examples 9-2 to 9-11 and Comparative Examples 9-1 to 9-2

Gel electrolyte secondary batteries of the respective Examples were obtained by following the same operations as in Example 9-1, except for changing the blending proportion of PVDF to PAN in the binder of the negative electrode as shown in Table 9. Specifications of the foregoing respective Examples are shown in Table 9.

TABLE 9

| | Binder (2.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 9-1 | 5/95 | 0.125 | 2.375 | 818 | 94 | 96 | 0.31 |
| Example 9-2 | 10/90 | 0.250 | 2.250 | 818 | 94 | 96 | 0.31 |
| Example 9-3 | 15/85 | 0.375 | 2.125 | 818 | 94 | 96 | 0.31 |
| Example 9-4 | 20/80 | 0.500 | 2.000 | 818 | 94 | 96 | 0.31 |
| Example 9-5 | 30/70 | 0.750 | 1.750 | 818 | 94 | 96 | 0.32 |
| Example 9-6 | 50/50 | 1.250 | 1.250 | 818 | 94 | 96 | 0.35 |
| Example 9-7 | 70/30 | 1.750 | 0.750 | 818 | 95 | 97 | 0.36 |
| Example 9-8 | 80/20 | 2.000 | 0.500 | 818 | 95 | 97 | 0.37 |
| Example 9-9 | 85/15 | 2.125 | 0.375 | 818 | 95 | 97 | 0.37 |
| Example 9-10 | 90/10 | 2.250 | 0.250 | 818 | 95 | 97 | 0.38 |
| Example 9-11 | 95/5 | 2.375 | 0.125 | 818 | 95 | 97 | 0.39 |
| Comparative | 0/100 | 0.000 | 2.500 | 818 | 94 | 72 | 0.51 |
| Example 9-1 | | | | | | | |
| Comparative | 100/0 | 2.500 | 0.000 | 818 | 95 | 91 | 0.54 |
| Example 9-2 | | | | | | | |

### Example 10-1

A gel electrolyte secondary battery of the present Example was obtained by following the same operations as in Example 1-1, except that a negative electrode mixture slurry obtained by uniformly mixing 96.0 parts by weight of artificial graphite as a negative electrode active substance and 0.200 parts by weight of PVdF and 3.800 parts by weight of PAN as a binder and adding NMP was used in the preparation of a negative electrode.

### Examples 10-2 to 10-11 and Comparative Examples 10-1 to 10-2

Gel electrolyte secondary batteries of the respective Examples were obtained by following the same operations as in Example 10-1, except for changing the blending proportion of PVdF to PAN in the binder of the negative electrode as shown in Table 10. Specifications of the foregoing respective Examples are shown in Table 10.

TABLE 10

| | Binder (4.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 10-1 | 5/95 | 0.200 | 3.800 | 807 | 94 | 95 | 0.34 |
| Example 10-2 | 10/90 | 0.400 | 3.600 | 807 | 94 | 95 | 0.34 |
| Example 10-3 | 15/85 | 0.600 | 3.400 | 807 | 94 | 95 | 0.34 |
| Example 10-4 | 20/80 | 0.800 | 3.200 | 807 | 94 | 95 | 0.34 |
| Example 10-5 | 30/70 | 1.200 | 2.800 | 807 | 94 | 95 | 0.35 |
| Example 10-6 | 50/50 | 2.000 | 2.000 | 807 | 94 | 95 | 0.37 |
| Example 10-7 | 70/30 | 2.800 | 1.200 | 807 | 95 | 96 | 0.38 |
| Example 10-8 | 80/20 | 3.200 | 0.800 | 807 | 95 | 96 | 0.38 |
| Example 10-9 | 85/15 | 3.400 | 0.600 | 807 | 95 | 96 | 0.38 |
| Example 10- | 90/10 | 3.600 | 0.400 | 807 | 95 | 96 | 0.40 |
| 10 | | | | | | | |
| Example 10- | 95/5 | 3.800 | 0.200 | 807 | 95 | 96 | 0.40 |
| 11 | | | | | | | |
| Comparative | 0/100 | 0.000 | 4.000 | 807 | 94 | 71 | 0.52 |
| Example 10-1 | | | | | | | |
| Comparative | 100/0 | 4.000 | 0.000 | 807 | 95 | 90 | 0.55 |
| Example 10-2 | | | | | | | |

### Example 11-1

A gel electrolyte secondary battery of the present Example was obtained by following the same operations as in Example 1-1, except that a negative electrode mixture slurry obtained by uniformly mixing 94.5 parts by weight of artificial graphite as a negative electrode active substance and 0.275 parts by weight of PVdF and 5.225 parts by weight of PAN as a binder and adding NMP was used in the preparation of a negative electrode.

### Examples 11-2 to 11-11 and Comparative Examples 11-1 to 11-2

Gel electrolyte secondary batteries of the respective Examples were obtained by following the same operations as in Example 11-1, except for changing the blending proportion of PVdF to PAN in the binder of the negative electrode as shown in Table 11. Specifications of the foregoing respective Examples are shown in Table 11.

TABLE 11

| | Binder (5.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 11-1 | 5/95 | 0.275 | 5.225 | 796 | 93 | 94 | 0.36 |
| Example 11-2 | 10/90 | 0.550 | 4.950 | 796 | 93 | 94 | 0.36 |
| Example 11-3 | 15/85 | 0.825 | 4.675 | 796 | 93 | 94 | 0.36 |
| Example 11-4 | 20/80 | 1.100 | 4.400 | 796 | 93 | 94 | 0.36 |
| Example 11-5 | 30/70 | 1.650 | 3.850 | 796 | 93 | 94 | 0.37 |
| Example 11-6 | 50/50 | 2.750 | 2.750 | 796 | 93 | 94 | 0.41 |
| Example 11-7 | 70/30 | 3.850 | 1.650 | 796 | 94 | 95 | 0.45 |
| Example 11-8 | 80/20 | 4.400 | 1.100 | 796 | 94 | 95 | 0.45 |
| Example 11-9 | 85/15 | 4.675 | 0.825 | 796 | 94 | 95 | 0.45 |
| Example 11- | 90/10 | 4.950 | 0.550 | 796 | 94 | 95 | 0.47 |
| 10 | | | | | | | |
| Example 11- | 95/5 | 5.225 | 0.275 | 796 | 94 | 95 | 0.47 |
| 11 | | | | | | | |
| Comparative | 0/100 | 0.000 | 5.500 | 796 | 93 | 70 | 0.53 |
| Example 11-1 | | | | | | | |
| Comparative | 100/0 | 5.500 | 0.000 | 796 | 94 | 90 | 0.61 |
| Example 11-2 | | | | | | | |

### Example 12-1

A gel electrolyte secondary battery of the present Example was obtained by following the same operations as in Example 1-1, except that a negative electrode mixture slurry obtained by uniformly mixing 92.0 parts by weight of artificial graphite as a negative electrode active substance and 0.400 parts by weight of PVdF and 7.600 parts by weight of PAN as a binder and adding NMP was used in the preparation of a negative electrode.

### Examples 12-2 to 12-11 and Comparative Examples 12-1 to 12-2

Gel electrolyte secondary batteries of the respective Examples were obtained by following the same operations as in Example 12-1, except for changing the blending proportion of PVdF to PAN in the binder of the negative electrode as shown in Table 12. Specifications of the foregoing respective Examples are shown in Table 12.

TABLE 12

| | Binder (8.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 12-1 | 5/95 | 0.400 | 7.600 | 772 | 75 | 70 | 0.56 |
| Example 12-2 | 10/90 | 0.800 | 7.200 | 772 | 75 | 70 | 0.56 |
| Example 12-3 | 15/85 | 1.200 | 6.800 | 777 | 75 | 70 | 0.56 |
| Example 12-4 | 20/80 | 1.600 | 6.400 | 772 | 75 | 70 | 0.56 |
| Example 12-5 | 30/70 | 2.400 | 5.600 | 772 | 75 | 70 | 0.57 |
| Example 12-6 | 50/50 | 4.000 | 4.000 | 772 | 75 | 70 | 0.59 |
| Example 12-7 | 70/30 | 5.600 | 2.400 | 772 | 76 | 71 | 0.60 |
| Example 12-8 | 80/20 | 6.400 | 1.600 | 772 | 76 | 71 | 0.60 |
| Example 12-9 | 85/15 | 6.800 | 1.200 | 772 | 76 | 71 | 0.60 |
| Example 12- | 90/10 | 7.200 | 0.800 | 772 | 76 | 71 | 0.61 |
| 10 | | | | | | | |
| Example 12- | 95/5 | 7.600 | 0.400 | 772 | 76 | 71 | 0.61 |
| 11 | | | | | | | |
| Comparative | 0/100 | 0.000 | 8.000 | 772 | 75 | 62 | 0.55 |
| Example 12-1 | | | | | | | |
| Comparative | 100/0 | 8.000 | 0.000 | 772 | 76 | 66 | 0.65 |
| Example 12-2 | | | | | | | |

### Example 13-1

A gel electrolyte secondary battery of the present Example was obtained by following the same operations as in Example 1-1, except that a negative electrode mixture slurry obtained by uniformly mixing 99.0 parts by weight of natural graphite as a negative electrode active substance and 0.200 parts by weight of PVdF and 0.800 parts by weight of PAN as a binder and adding NMP was used in the preparation of a negative electrode and that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monochlorotrifluoroethylene and polyvinylidene fluoride (total content of hexafluoropropylene and monochlorotrifluoroethylene: 7%) as a matrix polymer in a proportion of the matrix polymer to the electrolytic liquid of 1/6 (weight ratio) and using DMC as a solvent was used in the preparation of a gel non-aqueous electrolyte.

### Examples 13-2 to 13-3 and Comparative Examples 13-1 to 13-2

Gel electrolyte secondary batteries of the respective Examples were obtained by following the same operations as in Example 13-1, except for changing the blending proportion of PVdF to PAN in the binder of the negative electrode as shown in Table 13. Specifications of the foregoing respective Examples are shown in Table 13.

TABLE 13

| | Binder (1.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 13-1 | 20/80 | 0.200 | 0.800 | 840 | 76 | 69 | 0.56 |
| Example 13-2 | 50/50 | 0.500 | 0.500 | 840 | 76 | 69 | 0.58 |
| Example 13-3 | 80/20 | 0.800 | 0.200 | 840 | 77 | 70 | 0.59 |
| Comparative | 0/100 | 0.000 | 1.000 | 840 | 76 | 57 | 0.55 |
| Example 13-1 | | | | | | | |
| Comparative | 100/0 | 1.000 | 0.000 | 840 | 77 | 70 | 0.63 |
| Example 13-2 | | | | | | | |

### Example 14-1

A gel electrolyte secondary battery of the present Example was obtained by following the same operations as in Example 13-1, except that a negative electrode mixture slurry obtained by uniformly mixing 98.0 parts by weight of natural graphite as a negative electrode active substance and 0.400 parts by weight of PVdF and 1.600 parts by weight of PAN as a binder and adding NMP was used in the preparation of a negative electrode.

### Examples 14-2 to 14-3 and Comparative Examples 14-1 to 14-2

Gel electrolyte secondary batteries of the respective Examples were obtained by following the same operations as in Example 14-1, except for changing the blending proportion of PVdF to PAN in the binder of the negative electrode as shown in Table 14. Specifications of the foregoing respective Examples are shown in Table 14.

TABLE 14

| | Binder (2.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 14-1 | 20/80 | 0.400 | 1.600 | 832 | 94 | 95 | 0.31 |
| Example 14-2 | 50/50 | 1.000 | 1.000 | 832 | 94 | 95 | 0.35 |
| Example 14-3 | 80/20 | 1.600 | 0.400 | 832 | 95 | 96 | 0.36 |
| Comparative | 0/100 | 0.000 | 2.000 | 832 | 94 | 72 | 0.51 |
| Example 14-1 | | | | | | | |
| Comparative | 100/0 | 2.000 | 0.000 | 832 | 95 | 90 | 0.53 |
| Example 14-2 | | | | | | | |

### Example 15-1

A gel electrolyte secondary battery of the present Example was obtained by following the same operations as in Example 13-1, except that a negative electrode mixture slurry obtained by uniformly mixing 96.5 parts by weight of natural graphite as a negative electrode active substance and 0.700 parts by weight of PVdF and 2.800 parts by weight of PAN as a binder and adding NMP was used in the preparation of a negative electrode.

### Examples 15-2 to 15-3 and Comparative Examples 15-1 to 15-2

Get electrolyte secondary batteries of the respective Examples were obtained by following the same operations as in Example 15-1, except for changing the blending proportion of PVdF to PAN in the binder of the negative electrode as shown in Table 15. Specifications of the foregoing respective Examples are shown in Table 15.

TABLE 15

| | Binder (3.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 15-1 | 20/80 | 0.700 | 2.800 | 818 | 94 | 95 | 0.31 |
| Example 15-2 | 50/50 | 1.750 | 1.750 | 818 | 94 | 95 | 0.36 |
| Example 15-3 | 80/20 | 2.800 | 0.700 | 818 | 95 | 96 | 0.37 |
| Comparative | 0/100 | 0.000 | 3.500 | 818 | 94 | 72 | 0.52 |
| Example 15-1 | | | | | | | |
| Comparative | 100/0 | 3.500 | 0.000 | 818 | 95 | 90 | 0.53 |
| Example 15-2 | | | | | | | |

### Example 16-1

A gel electrolyte secondary battery of the present Example was obtained by following the same operations as in Example 13-1, except that a negative electrode mixture slurry obtained by uniformly mixing 95.0 parts by weight of natural graphite as a negative electrode active substance and 1.000 parts by weight of PVdF and 4.000 parts by weight of PAN as a binder and adding NMP was used in the preparation of a negative electrode.

### Examples 16-2 to 16-3 and Comparative Examples 16-1 to 16-2

Gel electrolyte secondary batteries of the respective Examples were obtained by following the same operations as in Example 16-1, except for changing the blending proportion of PVdF to PAN in the binder of the negative electrode as shown in Table 16. Specifications of the foregoing respective Examples are shown in Table 16.

TABLE 16

| | Binder (5.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 16-1 | 20/80 | 1.000 | 4.000 | 803 | 94 | 94 | 0.34 |
| Example 16-2 | 50/50 | 2.500 | 2.500 | 803 | 94 | 94 | 0.37 |
| Example 16-3 | 80/20 | 4.000 | 1.000 | 803 | 95 | 95 | 0.39 |
| Comparative | 0/100 | 0.000 | 5.000 | 803 | 94 | 71 | 0.53 |
| Example 16-1 | | | | | | | |
| Comparative | 100/0 | 5.000 | 0.000 | 803 | 95 | 90 | 0.56 |
| Example 16-2 | | | | | | | |

### Example 17-1

A gel electrolyte secondary battery of the present Example was obtained by following the same operations as in Example 13-1, except that a negative electrode mixture slurry obtained by uniformly mixing 93.5 parts by weight of natural graphite as a negative electrode active substance and 1.300 parts by weight of PVdF and 5.200 parts by weight of PAN as a binder and adding NMP was used in the preparation of a negative electrode.

### Examples 17-2 to 17-3 and Comparative Examples 17-1 to 17-2

Gel electrolyte secondary batteries of the respective Examples were obtained by following the same operations as in Example 17-1, except for changing the blending proportion of PVdF to PAN in the binder of the negative electrode as shown in Table 17. Specifications of the foregoing respective Examples are shown in Table 17.

TABLE 17

| | Binder (6.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 17-1 | 20/80 | 1.300 | 5.200 | 791 | 93 | 94 | 0.36 |
| Example 17-2 | 50/50 | 3.250 | 3.250 | 791 | 93 | 94 | 0.41 |
| Example 17-3 | 80/20 | 5.200 | 1.300 | 791 | 94 | 95 | 0.43 |
| Comparative | 0/100 | 0.000 | 6.500 | 791 | 93 | 70 | 0.54 |
| Example 17-1 | | | | | | | |
| Comparative | 100/0 | 6.500 | 0.000 | 791 | 94 | 90 | 0.62 |
| Example 17-2 | | | | | | | |

### Example 18-1

A gel electrolyte secondary battery of the present Example was obtained by following the same operations as in Example 13-1, except that a negative electrode mixture slurry obtained by uniformly mixing 92.0 parts by weight of natural graphite as a negative electrode active substance and 1.600 parts by weight of PVdF and 6.400 parts by weight of PAN as a binder and adding NMP was used in the preparation of a negative electrode.

### Examples 18-2 to 18-3 and Comparative Examples 18-1 to 18-2

Gel electrolyte secondary batteries of the respective Examples were obtained by following the same operations as in Example 18-1, except for changing the blending proportion of PVdF to PAN in the binder of the negative electrode as shown in Table 18. Specifications of the foregoing respective Examples are shown in Table 18.

TABLE 18

| | Binder (8.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 18-1 | 20/80 | 1.600 | 6.400 | 779 | 75 | 70 | 0.59 |
| Example 18-2 | 50/50 | 4.000 | 4.000 | 779 | 75 | 70 | 0.62 |
| Example 18-3 | 80/20 | 6.400 | 1.600 | 779 | 76 | 71 | 0.63 |
| Comparative | 0/100 | 0.000 | 8.000 | 779 | 75 | 60 | 0.58 |
| Example 18-1 | | | | | | | |
| Comparative | 100/0 | 8.000 | 0.000 | 779 | 76 | 64 | 0.69 |
| Example 18-2 | | | | | | | |

### Examples 19-1 to 19-3 and Comparative Examples 19-1 to 19-2

Gel electrolyte secondary batteries of the respective Examples were obtained by following the same operations as in Examples 13-1 to 13-3 and Comparative Examples 13-1 to 13-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 19.

TABLE 19

| | Binder (1.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 19-1 | 20/80 | 0.200 | 0.800 | 840 | 76 | 69 | 0.56 |
| Example 19-2 | 50/50 | 0.500 | 0.500 | 840 | 76 | 69 | 0.58 |
| Example 19-3 | 80/20 | 0.800 | 0.200 | 840 | 77 | 70 | 0.59 |
| Comparative | 0/100 | 0.000 | 1.000 | 840 | 76 | 57 | 0.55 |
| Example 19-1 | | | | | | | |
| Comparative | 100/0 | 1.000 | 0.000 | 840 | 77 | 70 | 0.63 |
| Example 19-2 | | | | | | | |

### Examples 20-1 to 20-3 and Comparative Examples 20-1 to 20-2

Gel electrolyte secondary batteries of the respective Examples were obtained by following the same operations as in Examples 14-1 to 14-3 and Comparative Examples 14-1 to 14-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 20.

TABLE 20

| | Binder (2.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 20-1 | 20/80 | 0.400 | 1.600 | 832 | 94 | 95 | 0.31 |
| Example 20-2 | 50/50 | 1.000 | 1.000 | 832 | 94 | 95 | 0.35 |
| Example 20-3 | 80/20 | 1.600 | 0.400 | 832 | 95 | 96 | 0.36 |
| Comparative | 0/100 | 0.000 | 2.000 | 832 | 94 | 72 | 0.51 |
| Example 20-1 | | | | | | | |
| Comparative | 100/0 | 2.000 | 0.000 | 832 | 95 | 90 | 0.53 |
| Example 20-2 | | | | | | | |

### Examples 21-1 to 21-3 and Comparative Examples 21-1 to 21-2

Gel electrolyte secondary batteries of the respective Examples were obtained by following the same operations as in Examples 15-1 to 15-3 and Comparative Examples 15-1 to 15-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 21.

TABLE 21

| | Binder (3.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 21-1 | 20/80 | 0.700 | 2.800 | 818 | 94 | 95 | 0.31 |
| Example 21-2 | 50/50 | 1.750 | 1.750 | 818 | 94 | 95 | 0.36 |
| Example 21-3 | 80/20 | 2.800 | 0.700 | 818 | 95 | 96 | 0.37 |
| Comparative | 0/100 | 0.000 | 3.500 | 818 | 94 | 72 | 0.52 |
| Example 21-1 | | | | | | | |
| Comparative | 100/0 | 3.500 | 0.000 | 818 | 95 | 90 | 0.53 |
| Example 21-2 | | | | | | | |

### Examples 22-1 to 22-3 and Comparative Examples 22-1 to 22-2

Gel electrolyte secondary batteries of the respective Examples were obtained by following the same operations as in Examples 16-1 to 16-3 and Comparative Examples 16-1 to 16-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 22.

TABLE 22

| | Binder (5.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 22-1 | 20/80 | 1.000 | 4.000 | 803 | 94 | 94 | 0.34 |
| Example 22-2 | 50/50 | 2.500 | 2.500 | 803 | 94 | 94 | 0.37 |
| Example 22-3 | 80/20 | 4.000 | 1.000 | 803 | 95 | 95 | 0.39 |
| Comparative | 0/100 | 0.000 | 5.000 | 803 | 94 | 71 | 0.53 |
| Example 22-1 | | | | | | | |
| Comparative | 100/0 | 5.000 | 0.000 | 803 | 95 | 90 | 0.56 |
| Example 22-2 | | | | | | | |

### Examples 23-1 to 23-3 and Comparative Examples 23-1 to 23-2

Gel electrolyte secondary batteries of the respective Examples were obtained by following the same operations as in Examples 17-1 to 17-3 and Comparative Examples 17-1 to 17-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 23.

TABLE 23

| | Binder (6.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 23-1 | 20/80 | 1.300 | 5.200 | 791 | 93 | 94 | 0.36 |
| Example 23-2 | 50/50 | 3.250 | 3.250 | 791 | 93 | 94 | 0.41 |
| Example 23-3 | 80/20 | 5.200 | 1.300 | 791 | 94 | 95 | 0.43 |
| Comparative | 0/100 | 0.000 | 6.500 | 791 | 93 | 70 | 0.54 |
| Example 23-1 | | | | | | | |
| Comparative | 100/0 | 6.500 | 0.000 | 791 | 94 | 90 | 0.62 |
| Example 23-2 | | | | | | | |

### Examples 24-1 to 24-3 and Comparative Examples 24-1 to 24-2

Gel electrolyte secondary batteries of the respective Examples were obtained by following the same operations as in Examples 18-1 to 18-3 and Comparative Examples 18-1 to 18-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 24.

TABLE 24

| | Binder (8.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 24-1 | 20/80 | 1.600 | 6.400 | 779 | 75 | 70 | 0.59 |
| Example 24-2 | 50/50 | 4.000 | 4.000 | 779 | 75 | 70 | 0.62 |
| Example 24-3 | 80/20 | 6.400 | 1.600 | 779 | 76 | 71 | 0.63 |
| Comparative | 0/100 | 0.000 | 8.000 | 779 | 75 | 60 | 0.58 |
| Example 24-1 | | | | | | | |
| Comparative | 100/0 | 8.000 | 0.000 | 779 | 76 | 64 | 0.69 |
| Example 24-2 | | | | | | | |

### Example 25-1

A gel electrolyte secondary battery of the present Example was obtained by following the same operations as in Example 13-1, except that a negative electrode mixture slurry obtained by uniformly mixing 99.0 parts by weight of artificial graphite as a negative electrode active substance and 0.200 parts by weight of PVdF and 0.800 parts by weight of PAN as a binder and adding NMP was used in the preparation of a negative electrode and that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monochlorotrifluoroethylene and polyvinylidene fluoride (total content of hexafluoropropylene and monochlorotrifluoroethylene: 7%) as a matrix polymer in a proportion of the matrix polymer to the electrolytic liquid of 1/6 (weight ratio) and using DMC as a solvent was used in the preparation of a gel non-aqueous electrolyte.

### Examples 25-2 to 25-3 and Comparative Examples 25-1 to 25-2

Gel electrolyte secondary batteries of the respective Examples were obtained by following the same operations as in Example 25-1, except for changing the blending proportion of PVdF to PAN in the binder of the negative electrode as shown in Table 25. Specifications of the foregoing respective Examples are shown in Table 25.

TABLE 25

| | Binder (1.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 25-1 | 20/80 | 0.200 | 0.800 | 830 | 76 | 70 | 0.52 |
| Example 25-2 | 50/50 | 0.500 | 0.500 | 830 | 76 | 70 | 0.54 |
| Example 25-3 | 80/20 | 0.800 | 0.200 | 830 | 77 | 71 | 0.55 |
| Comparative | 0/100 | 0.000 | 1.000 | 830 | 76 | 60 | 0.51 |
| Example 25-1 | | | | | | | |
| Comparative | 100/0 | 1.000 | 0.000 | 830 | 77 | 65 | 0.56 |
| Example 25-2 | | | | | | | |

### Example 26-1

A gel electrolyte secondary battery of the present Example was obtained by following the same operations as in Example 25-1, except that a negative electrode mixture slurry obtained by uniformly mixing 98.0 parts by weight of artificial graphite as a negative electrode active substance and 0.400 parts by weight of PVDF and 1.600 parts by weight of PAN as a binder and adding NMP was used in the preparation of a negative electrode.

### Examples 26-2 to 26-3 and Comparative Examples 26-1 to 26-2

Gel electrolyte secondary batteries of the respective Examples were obtained by following the same operations as in Example 26-1, except for changing the blending proportion of PVdF to PAN in the binder of the negative electrode as shown in Table 26. Specifications of the foregoing respective Examples are shown in Table 26.

TABLE 26

| | Binder (2.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 26-1 | 20/80 | 0.400 | 1.600 | 822 | 94 | 96 | 0.31 |
| Example 26-2 | 50/50 | 1.000 | 1.000 | 822 | 94 | 96 | 0.35 |
| Example 26-3 | 80/20 | 1.600 | 0.400 | 822 | 95 | 97 | 0.37 |
| Comparative | 0/100 | 0.000 | 2.000 | 822 | 94 | 72 | 0.51 |
| Example 26-1 | | | | | | | |
| Comparative | 100/0 | 2.000 | 0.000 | 822 | 95 | 91 | 0.53 |
| Example 26-2 | | | | | | | |

### Example 27-1

A gel electrolyte secondary battery of the present Example was obtained by following the same operations as in Example 25-1, except that a negative electrode mixture slurry obtained by uniformly mixing 97.5 parts by weight of artificial graphite as a negative electrode active substance and 0.500 parts by weight of PVdF and 2.000 parts by weight of PAN as a binder and adding NMP was used in the preparation of a negative electrode.

### Examples 27-2 to 27-3 and Comparative Examples 27-1 to 27-2

Gel electrolyte secondary batteries of the respective Examples were obtained by following the same operations as in Example 27-1, except for changing the blending proportion of PVdF to PAN in the binder of the negative electrode as shown in Table 27. Specifications of the foregoing respective Examples are shown in Table 27.

TABLE 27

| | Binder (2.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 27-1 | 20/80 | 0.500 | 2.000 | 818 | 94 | 96 | 0.31 |
| Example 27-2 | 50/50 | 1.250 | 1.250 | 818 | 94 | 96 | 0.35 |
| Example 27-3 | 80/20 | 2.000 | 0.500 | 818 | 95 | 97 | 0.37 |
| Comparative | 0/100 | 0.000 | 2.500 | 818 | 94 | 72 | 0.51 |
| Example 27-1 | | | | | | | |
| Comparative | 100/0 | 2.500 | 0.000 | 818 | 95 | 91 | 0.54 |
| Example 27-2 | | | | | | | |

### Example 28-1

A gel electrolyte secondary battery of the present Example was obtained by following the same operations as in Example 25-1, except that a negative electrode mixture slurry obtained by uniformly mixing 96.0 parts by weight of artificial graphite as a negative electrode active substance and 0.800 parts by weight of PVdF and 3.200 parts by weight of PAN as a binder and adding NMP was used in the preparation of a negative electrode.

### Examples 28-2 to 28-3 and Comparative Examples 28-1 to 28-2

Gel electrolyte secondary batteries of the respective Examples were obtained by following the same operations as in Example 28-1, except for changing the blending proportion of PVdF to PAN in the binder of the negative electrode as shown in Table 28. Specifications of the foregoing respective Examples are shown in Table 28.

TABLE 28

| | Binder (4.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 28-1 | 20/80 | 0.800 | 3.200 | 807 | 94 | 95 | 0.34 |
| Example 28-2 | 50/50 | 2.000 | 2.000 | 807 | 94 | 95 | 0.37 |
| Example 28-3 | 80/20 | 3.200 | 0.800 | 807 | 95 | 96 | 0.38 |
| Comparative | 0/100 | 0.000 | 4.000 | 807 | 94 | 71 | 0.52 |
| Example 28-1 | | | | | | | |
| Comparative | 100/0 | 4.000 | 0.000 | 807 | 95 | 90 | 0.55 |
| Example 28-2 | | | | | | | |

### Example 29-1

A gel electrolyte secondary battery of the present Example was obtained by following the same operations as in Example 25-1, except that a negative electrode mixture slurry obtained by uniformly mixing 94.5 parts by weight of artificial graphite as a negative electrode active substance and 1.100 parts by weight of PVdF and 4.400 parts by weight of PAN as a binder and adding NMP was used in the preparation of a negative electrode.

### Examples 29-2 to 29-3 and Comparative Examples 29-1 to 29-2

Gel electrolyte secondary batteries of the respective Examples were obtained by following the same operations as in Example 29-1, except for changing the blending proportion of PVdF to PAN in the binder of the negative electrode as shown in Table 29. Specifications of the foregoing respective Examples are shown in Table 29.

TABLE 29

| | Binder (5.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 29-1 | 20/80 | 1.100 | 4.400 | 796 | 93 | 94 | 0.36 |
| Example 29-2 | 50/50 | 2.750 | 2.750 | 796 | 93 | 94 | 0.41 |
| Example 29-3 | 80/20 | 4.400 | 1.100 | 796 | 94 | 95 | 0.45 |
| Comparative | 0/100 | 0.000 | 5.500 | 796 | 93 | 70 | 0.53 |
| Example 29-1 | | | | | | | |
| Comparative | 100/0 | 5.500 | 0.000 | 796 | 94 | 90 | 0.61 |
| Example 29-2 | | | | | | | |

### Example 30-1

A gel electrolyte secondary battery of the present Example was obtained by following the same operations as in Example 25-1, except that a negative electrode mixture slurry obtained by uniformly mixing 92.0 parts by weight of artificial graphite as a negative electrode active substance and 1.600 parts by weight of PVdF and 6.400 parts by weight of PAN as a binder and adding NMP was used in the preparation of a negative electrode.

### Examples 30-2 to 30-3 and Comparative Examples 30-1 to 30-2

Gel electrolyte secondary batteries of the respective Examples were obtained by following the same operations as in Example 30-1, except for changing the blending proportion of PVdF to PAN in the binder of the negative electrode as shown in Table 30. Specifications of the foregoing respective Examples are shown in Table 30.

TABLE 30

| | Binder (8.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 30-1 | 20/80 | 1.600 | 6.400 | 772 | 75 | 70 | 0.56 |
| Example 30-2 | 50/50 | 4.000 | 4.000 | 772 | 75 | 70 | 0.59 |
| Example 30-3 | 80/20 | 6.400 | 1.600 | 772 | 76 | 71 | 0.60 |
| Comparative | 0/100 | 0.000 | 8.000 | 772 | 75 | 62 | 0.55 |
| Example 30-1 | | | | | | | |
| Comparative | 100/0 | 8.000 | 0.000 | 772 | 76 | 66 | 0.65 |
| Example 30-2 | | | | | | | |

### Examples 31-1 to 31-3 and Comparative Examples 31-1 to 31-2

Gel electrolyte secondary batteries of the respective Examples were obtained by following the same operations as in Examples 25-1 to 25-3 and Comparative Examples 25-1 to 25-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 31.

TABLE 31

| | Binder (1.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 31-1 | 20/80 | 0.200 | 0.800 | 830 | 76 | 70 | 0.52 |
| Example 31-2 | 50/50 | 0.500 | 0.500 | 830 | 76 | 70 | 0.54 |
| Example 31-3 | 80/20 | 0.800 | 0.200 | 830 | 77 | 71 | 0.55 |
| Comparative | 0/100 | 0.000 | 1.000 | 830 | 76 | 60 | 0.51 |
| Example 31-1 | | | | | | | |
| Comparative | 100/0 | 1.000 | 0.000 | 830 | 77 | 65 | 0.56 |
| Example 31-2 | | | | | | | |

### Examples 32-1 to 32-3 and Comparative Examples 32-1 to 32-2

Gel electrolyte secondary batteries of the respective Examples were obtained by following the same operations as in Examples 26-1 to 26-3 and Comparative Examples 26-1 to 26-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 32.

TABLE 32

| | Binder (2.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 32-1 | 20/80 | 0.400 | 1.600 | 822 | 94 | 96 | 0.31 |
| Example 32-2 | 50/50 | 1.000 | 1.000 | 822 | 94 | 96 | 0.35 |
| Example 32-3 | 80/20 | 1.600 | 0.400 | 822 | 95 | 97 | 0.37 |
| Comparative | 0/100 | 0.000 | 2.000 | 822 | 94 | 72 | 0.51 |
| Example 32-1 | | | | | | | |
| Comparative | 100/0 | 2.000 | 0.000 | 822 | 95 | 91 | 0.53 |
| Example 32-2 | | | | | | | |

### Examples 33-1 to 33-3 and Comparative Examples 33-1 to 33-2

Gel electrolyte secondary batteries of the respective Examples were obtained by following the same operations as in Examples 27-1 to 27-3 and Comparative Examples 27-1 to 27-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 33.

TABLE 33

| | Binder (2.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 33-1 | 20/80 | 0.500 | 2.000 | 818 | 94 | 96 | 0.31 |
| Example 33-2 | 50/50 | 1.250 | 1.250 | 818 | 94 | 96 | 0.35 |
| Example 33-3 | 80/20 | 2.000 | 0.500 | 818 | 95 | 97 | 0.37 |
| Comparative | 0/100 | 0.000 | 2.500 | 818 | 94 | 72 | 0.51 |
| Example 33-1 | | | | | | | |
| Comparative | 100/0 | 2.500 | 0.000 | 818 | 95 | 91 | 0.54 |
| Example 33-2 | | | | | | | |

### Examples 34-1 to 34-3 and Comparative Examples 34-1 to 34-2

Gel electrolyte secondary batteries of the respective Examples were obtained by following the same operations as in Examples 28-1 to 28-3 and Comparative Examples 28-1 to 28-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent Was used in the preparation of a gel non-aqueous electrolyte. Specifications of the foregoing respective Examples are shown in Table 34.

TABLE 34

| | Binder (4.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 34-1 | 20/80 | 0.800 | 3.200 | 807 | 94 | 95 | 0.34 |
| Example 34-2 | 50/50 | 2.000 | 2.000 | 807 | 94 | 95 | 0.37 |
| Example 34-3 | 80/20 | 3.200 | 0.800 | 807 | 95 | 96 | 0.38 |
| Comparative | 0/100 | 0.000 | 4.000 | 807 | 94 | 71 | 0.52 |
| Example 34-1 | | | | | | | |
| Comparative | 100/0 | 4.000 | 0.000 | 807 | 95 | 90 | 0.55 |
| Example 34-2 | | | | | | | |

### Examples 35-1 to 35-3 and Comparative Examples 35-1 to 35-2

Gel electrolyte secondary batteries of the respective Examples were obtained by following the same operations as in Examples 29-1 to 29-3 and Comparative Examples 29-1 to 29-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 35.

TABLE 35

| | Binder (5.5%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 35-1 | 20/80 | 1.100 | 4.400 | 796 | 93 | 94 | 0.36 |
| Example 35-2 | 50/50 | 2.750 | 2.750 | 796 | 93 | 94 | 0.41 |
| Example 35-3 | 80/20 | 4.400 | 1.100 | 796 | 94 | 95 | 0.45 |
| Comparative | 0/100 | 0.000 | 5.500 | 796 | 93 | 70 | 0.53 |
| Example 35-1 | | | | | | | |
| Comparative | 100/0 | 5.500 | 0.000 | 796 | 94 | 90 | 0.61 |
| Example 35-2 | | | | | | | |

### Examples 36-1 to 36-3 and Comparative Examples 36-1 to 36-2

Gel electrolyte secondary batteries of the respective Examples were obtained by following the same operations as in Examples 30-1 to 30-3 and Comparative Examples 30-1 to 30-2, respectively, except that a sol non-aqueous electrolyte obtained by dissolving 1 mole/kg of LiPF₆ as an electrolyte salt in a non-aqueous solvent obtained by mixing EC and PC in a proportion of EC to PC of 4/6 (weight ratio) to prepare an electrolytic liquid, mixing with a copolymer of hexafluoropropylene, monomethyl maleate and polyvinylidene fluoride (total content of hexafluoropropylene and monomethyl maleate: 7%) as a matrix polymer in a proportion of the matrix polymer to the electrolytic liquid of 1/6 (weight ratio) and using DMC as a solvent was used in the preparation of a gel non-aqueous electrolyte. Specifications of the foregoing respective Examples are shown in Table 36.

TABLE 36

| | Binder (8.0%) | | | | | | Increasing |
|---|---|---|---|---|---|---|---|
| | | PVdF | PAN | Battery | Load | Cycle | amount of |
| | | (parts by | (parts by | capacity | characteristic | characteristic | thickness |
| | PVdF/PAN | weight) | weight) | (mAh) | (%) | (%) | (mm) |
| Example 36-1 | 20/80 | 1.600 | 6.400 | 772 | 75 | 70 | 0.56 |
| Example 36-2 | 50/50 | 4.000 | 4.000 | 772 | 75 | 70 | 0.59 |
| Example 36-3 | 80/20 | 6.400 | 1.600 | 772 | 76 | 71 | 0.60 |
| Comparative | 0/100 | 0.000 | 8.000 | 772 | 75 | 62 | 0.55 |
| Example 36-1 | | | | | | | |
| Comparative | 100/0 | 8.000 | 0.000 | 772 | 76 | 66 | 0.65 |
| Example 36-2 | | | | | | | |

### Example 37-1

A gel electrolyte secondary battery of the present Example was obtained by following the same operations as in Example 1-1, except that a negative electrode mixture slurry obtained by uniformly mixing 99.0 parts by weight of natural graphite as a negative electrode active substance and 0.10 parts by weight of PVdF and 0.90 parts by weight of a styrene-butadiene rubber (SBR) as a binder and adding NMP was used in the preparation of a negative electrode.

### Examples 37-2 to 37-5 and Comparative Examples 37-1 to 37-2

Gel electrolyte secondary batteries of the respective Examples were obtained by following the same operations as in Example 37-1, except for changing the blending proportion of PVdF to SBR in the binder of the negative electrode as shown in Table 37. Specifications of the foregoing respective Examples are shown in Table 37.

TABLE 37

| | Binder (1.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 37-1 | 10/90 | 0.10 | 0.90 | 838 | 77 | 60 |
| Example 37-2 | 30/70 | 0.30 | 0.70 | 838 | 77 | 69 |
| Example 37-3 | 50/50 | 0.50 | 0.50 | 838 | 77 | 58 |
| Example 37-4 | 70/30 | 0.70 | 0.30 | 838 | 77 | 57 |
| Example 37-5 | 90/10 | 0.90 | 0.10 | 838 | 77 | 46 |
| Comparative | 0/100 | 0.00 | 1.00 | 838 | 77 | 58 |
| Example 37-1 | | | | | | |
| Comparative | 100/0 | 1.00 | 0.00 | 838 | 77 | 41 |
| Example 37-2 | | | | | | |

### Example 38-1

A gel electrolyte secondary battery of the present Example was obtained by following the same operations as in Example 37-1, except that a negative electrode mixture slurry obtained by uniformly mixing 98.0 parts by weight of natural graphite as a negative electrode active substance and 0.20 parts by weight of PVdF and 1.80 parts by weight of SBR as a binder and adding NMP was used in the preparation of a negative electrode.

### Examples 38-2 to 38-5 and Comparative Examples 38-1 to 38-2

Gel electrolyte secondary batteries of the respective Examples were obtained by following the same operations as in Example 38-1, except for changing the blending proportion of PVdF to SBR in the binder of the negative electrode as shown in Table 38. Specifications of the foregoing respective Examples are shown in Table 38.

TABLE 38

| | Binder (2.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 38-1 | 10/90 | 0.20 | 1.80 | 830 | 95 | 86 |
| Example 38-2 | 30/70 | 0.60 | 1.40 | 830 | 95 | 84 |
| Example 38-3 | 50/50 | 1.00 | 1.00 | 830 | 95 | 78 |
| Example 38-4 | 70/30 | 1.40 | 0.60 | 830 | 95 | 77 |
| Example 38-5 | 90/10 | 1.80 | 0.20 | 830 | 95 | 66 |
| Comparative | 0/100 | 0.00 | 2.00 | 830 | 95 | 82 |
| Example 38-1 | | | | | | |
| Comparative | 100/0 | 2.00 | 0.00 | 830 | 95 | 64 |
| Example 38-2 | | | | | | |

### Example 39-1

A gel electrolyte secondary battery of the present Example was obtained by following the same operations as in Example 37-1, except that a negative electrode mixture slurry obtained by uniformly mixing 96.5 parts by weight of natural graphite as a negative electrode active substance and 0.35 parts by weight of PVdF and 3.15 parts by weight of SBR as a binder and adding NMP was used in the preparation of a negative electrode.

### Examples 39-2 to 39-5 and Comparative Examples 39-1 to 39-2

Gel electrolyte secondary batteries of the respective Examples were obtained by following the same operations as in Example 39-1, except for changing the blending proportion of PVdF to SBR in the binder of the negative electrode as shown in Table 39. Specifications of the foregoing respective Examples are shown in Table 39.

TABLE 39

| | Binder (3.5%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 39-1 | 10/90 | 0.35 | 3.15 | 816 | 95 | 83 |
| Example 39-2 | 30/70 | 1.05 | 2.45 | 816 | 95 | 90 |
| Example 39-3 | 50/50 | 1.75 | 1.75 | 816 | 95 | 93 |
| Example 39-4 | 70/30 | 2.45 | 1.05 | 816 | 95 | 95 |
| Example 39-5 | 90/10 | 3.15 | 0.35 | 816 | 95 | 92 |
| Comparative | 0/100 | 0.00 | 3.50 | 816 | 95 | 82 |
| Example 39-1 | | | | | | |
| Comparative | 100/0 | 3.50 | 0.00 | 816 | 95 | 79 |
| Example 39-2 | | | | | | |

### Example 40-1

A gel electrolyte secondary battery of the present Example was obtained by following the same operations as in Example 37-1, except that a negative electrode mixture slurry obtained by uniformly mixing 95.0 parts by weight of natural graphite as a negative electrode active substance and 0.50 parts by weight of PVdF and 4.50 parts by weight of SBR as a binder and adding NMP was used in the preparation of a negative electrode.

### Examples 40-2 to 40-5 and Comparative Examples 40-1 to 40-2

Gel electrolyte secondary batteries of the respective Examples were obtained by following the same operations as in Example 40-1, except for changing the blending proportion of PVdF to SBR in the binder of the negative electrode as shown in Table 40. Specifications of the foregoing respective Examples are shown in Table 40.

TABLE 40

| | Binder (5.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 40-1 | 10/90 | 0.50 | 4.50 | 801 | 95 | 76 |
| Example 40-2 | 30/70 | 1.50 | 3.50 | 801 | 95 | 84 |
| Example 40-3 | 50/50 | 2.50 | 2.50 | 801 | 95 | 90 |
| Example 40-4 | 70/30 | 3.50 | 1.50 | 801 | 95 | 95 |
| Example 40-5 | 90/10 | 4.50 | 0.50 | 801 | 95 | 93 |
| Comparative | 0/100 | 0.00 | 5.00 | 801 | 95 | 70 |
| Example 40-1 | | | | | | |
| Comparative | 100/0 | 5.00 | 0.00 | 801 | 95 | 87 |
| Example 40-2 | | | | | | |

### Example 41-1

A gel electrolyte secondary battery of the present Example was obtained by following the same operations as in Example 37-1, except that a negative electrode mixture slurry obtained by uniformly mixing 93.5 parts by weight of natural graphite as a negative electrode active substance and 0.65 parts by weight of PVdF and 5.85 parts by weight of SBR as a binder and adding NMP was used in the preparation of a negative electrode.

### Examples 41-2 to 41-5 and Comparative Examples 41-1 to 41-2

Gel electrolyte secondary batteries of the respective Examples were obtained by following the same operations as in Example 41-1, except for changing the blending proportion of PVdF to SBR in the binder of the negative electrode as shown in Table 41. Specifications of the foregoing respective Examples are shown in Table 41.

TABLE 41

| | Binder (6.5%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 41-1 | 10/90 | 0.65 | 5.85 | 789 | 94 | 74 |
| Example 41-2 | 30/70 | 1.95 | 4.55 | 789 | 94 | 82 |
| Example 41-3 | 50/50 | 3.25 | 3.25 | 789 | 94 | 90 |
| Example 41-4 | 70/30 | 4.55 | 1.95 | 789 | 94 | 94 |
| Example 41-5 | 90/10 | 5.85 | 0.65 | 789 | 94 | 95 |
| Comparative | 0/100 | 0.00 | 6.50 | 789 | 94 | 66 |
| Example 41-1 | | | | | | |
| Comparative | 100/0 | 6.50 | 0.00 | 789 | 94 | 90 |
| Example 41-2 | | | | | | |

### Example 42-1

A gel electrolyte secondary battery of the present Example was obtained by following the same operations as in Example 37-1, except that a negative electrode mixture slurry obtained by uniformly mixing 92.0 parts by weight of natural graphite as a negative electrode active substance and 0.80 parts by weight of PVdF and 7.20 parts by weight of SBR as a binder and adding NMP was used in the preparation of a negative electrode.

### Examples 42-2 to 42-5 and Comparative Examples 42-1 to 42-2

Gel electrolyte secondary batteries of the respective Examples were obtained by following the same operations as in Example 42-1, except for changing the blending proportion of PVdF to SBR in the binder of the negative electrode as shown in Table 42. Specifications of the foregoing respective Examples are shown in Table 42.

TABLE 42

| | Binder (8.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 42-1 | 10/90 | 0.80 | 7.20 | 777 | 76 | 58 |
| Example 42-2 | 30/70 | 2.40 | 5.60 | 777 | 76 | 68 |
| Example 42-3 | 50/50 | 4.00 | 4.00 | 777 | 76 | 76 |
| Example 42-4 | 70/30 | 5.60 | 2.40 | 777 | 76 | 84 |
| Example 42-5 | 90/10 | 7.20 | 0.80 | 777 | 76 | 89 |
| Comparative | 0/100 | 0.00 | 8.00 | 777 | 76 | 49 |
| Example 42-1 | | | | | | |
| Comparative | 100/0 | 8.00 | 0.00 | 777 | 76 | 80 |
| Example 42-2 | | | | | | |

### Example 43-1

A gel electrolyte secondary battery of the present Example was obtained by following the same operations as in Example 37-1, except that a negative electrode mixture slurry obtained by uniformly mixing 99.0 parts by weight of artificial graphite as a negative electrode active substance and 0.10 parts by weight of PVdF and 0.90 parts by weight of SBR as a binder and adding NMP was used in the preparation of a negative electrode.

### Examples 43-2 to 43-5 and Comparative Examples 43-1 to 43-2

Gel electrolyte secondary batteries of the respective Examples were obtained by following the same operations as in Example 43-1, except for changing the blending proportion of PVdF to SBR in the binder of the negative electrode as shown in Table 43. Specifications of the foregoing respective Examples are shown in Table 43.

TABLE 43

| | Binder (1.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 43-1 | 10/90 | 0.10 | 0.90 | 827 | 75 | 61 |
| Example 43-2 | 30/70 | 0.30 | 0.70 | 827 | 75 | 70 |
| Example 43-3 | 50/50 | 0.50 | 0.50 | 827 | 75 | 59 |
| Example 43-4 | 70/30 | 0.70 | 0.30 | 827 | 75 | 58 |
| Example 43-5 | 90/10 | 0.90 | 0.10 | 827 | 75 | 47 |
| Comparative | 0/100 | 0.00 | 1.00 | 827 | 75 | 59 |
| Example 43-1 | | | | | | |
| Comparative | 100/0 | 1.00 | 0.00 | 827 | 75 | 42 |
| Example 43-2 | | | | | | |

### Example 44-1

A gel electrolyte secondary battery of the present Example was obtained by following the same operations as in Example 37-1, except that a negative electrode mixture slurry obtained by uniformly mixing 98.0 parts by weight of artificial graphite as a negative electrode active substance and 0.20 parts by weight of PVdF and 1.80 parts by weight of SBR as a binder and adding NMP was used in the preparation of a negative electrode.

### Examples 44-2 to 44-5 and Comparative Examples 44-1 to 44-2

Gel electrolyte secondary batteries of the respective Examples were obtained by following the same operations as in Example 44-1, except for changing the blending proportion of PVdF to SBR in the binder of the negative electrode as shown in Table 44. Specifications of the foregoing respective Examples are shown in Table 44.

TABLE 44

| | Binder (2.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 44-1 | 10/90 | 0.20 | 1.80 | 819 | 93 | 87 |
| Example 44-2 | 30/70 | 0.60 | 1.40 | 819 | 93 | 85 |
| Example 44-3 | 50/50 | 1.00 | 1.00 | 819 | 93 | 79 |
| Example 44-4 | 70/30 | 1.40 | 0.60 | 819 | 93 | 78 |
| Example 44-5 | 90/10 | 1.80 | 0.20 | 819 | 93 | 67 |
| Comparative | 0/100 | 0.00 | 2.00 | 819 | 93 | 83 |
| Example 44-1 | | | | | | |
| Comparative | 100/0 | 2.00 | 0.00 | 819 | 93 | 65 |
| Example 44-2 | | | | | | |

### Example 45-1

A gel electrolyte secondary battery of the present Example was obtained by following the same operations as in Example 37-1, except that a negative electrode mixture slurry obtained by uniformly mixing 97.5 parts by weight of artificial graphite as a negative electrode active substance and 0.25 parts by weight of PVdF and 2.25 parts by weight of SBR as a binder and adding NMP was used in the preparation of a negative electrode.

### Examples 45-2 to 45-5 and Comparative Examples 45-1 to 45-2

Gel electrolyte secondary batteries of the respective Examples were obtained by following the same operations as in Example 45-1, except for changing the blending proportion of PVdF to SBR in the binder of the negative electrode as shown in Table 45. Specifications of the foregoing respective Examples are shown in Table 45.

TABLE 45

| | Binder (2.5%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 45-1 | 10/90 | 0.25 | 2.25 | 815 | 93 | 86 |
| Example 45-2 | 30/70 | 0.75 | 1.75 | 815 | 93 | 91 |
| Example 45-3 | 50/50 | 1.25 | 1.25 | 815 | 93 | 91 |
| Example 45-4 | 70/30 | 1.75 | 0.75 | 815 | 93 | 90 |
| Example 45-5 | 90/10 | 2.25 | 0.25 | 815 | 93 | 86 |
| Comparative | 0/100 | 0.00 | 2.50 | 815 | 93 | 83 |
| Example 45-1 | | | | | | |
| Comparative | 100/0 | 2.50 | 0.00 | 815 | 93 | 86 |
| Example 45-2 | | | | | | |

### Example 46-1

A gel electrolyte secondary battery of the present Example was obtained by following the same operations as in Example 37-1, except that a negative electrode mixture slurry obtained by uniformly mixing 96.0 parts by weight of artificial graphite as a negative electrode active substance and 0.40 parts by weight of PVdF and 3.60 parts by weight of SBR as a binder and adding NMP was used in the preparation of a negative electrode.

### Examples 46-2 to 46-5 and Comparative Examples 46-1 to 46-2

Gel electrolyte secondary batteries of the respective Examples were obtained by following the same operations as in Example 46-1, except for changing the blending proportion of PVdF to SBR in the binder of the negative electrode as shown in Table 46. Specifications of the foregoing respective Examples are shown in Table 46.

TABLE 46

| | Binder (4.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 46-1 | 10/90 | 0.40 | 3.60 | 804 | 93 | 82 |
| Example 46-2 | 30/70 | 1.20 | 2.80 | 804 | 93 | 84 |
| Example 46-3 | 50/50 | 2.00 | 2.00 | 804 | 93 | 92 |
| Example 46-4 | 70/30 | 2.80 | 1.20 | 804 | 93 | 96 |
| Example 46-5 | 90/10 | 3.60 | 0.40 | 804 | 93 | 93 |
| Comparative | 0/100 | 0.00 | 4.00 | 804 | 93 | 82 |
| Example 46-1 | | | | | | |
| Comparative | 100/0 | 4.00 | 0.00 | 804 | 93 | 87 |
| Example 46-2 | | | | | | |

### Example 47-1

A gel electrolyte secondary battery of the present Example was obtained by following the same operations as in Example 37-1, except that a negative electrode mixture slurry obtained by uniformly mixing 94.5 parts by weight of artificial graphite as a negative electrode active substance and 0.55 parts by weight of PVdF and 4.95 parts by weight of SBR as a binder and adding NMP was used in the preparation of a negative electrode.

### Examples 47-2 to 47-5 and Comparative Examples 47-1 to 47-2

Gel electrolyte secondary batteries of the respective Examples were obtained by following the same operations as in Example 47-1, except for changing the blending proportion of PVdF to SBR in the binder of the negative electrode as shown in Table 47. Specifications of the foregoing respective Examples are shown in Table 47.

TABLE 47

| | Binder (5.5%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 47-1 | 10/90 | 0.55 | 4.95 | 793 | 92 | 77 |
| Example 47-2 | 30/70 | 1.65 | 3.85 | 793 | 92 | 85 |
| Example 47-3 | 50/50 | 2.75 | 2.75 | 793 | 92 | 91 |
| Example 47-4 | 70/30 | 3.85 | 1.65 | 793 | 92 | 96 |
| Example 47-5 | 90/10 | 4.95 | 0.55 | 793 | 92 | 94 |
| Comparative | 0/100 | 0.00 | 5.50 | 793 | 92 | 71 |
| Example 47-1 | | | | | | |
| Comparative | 100/0 | 5.50 | 0.00 | 793 | 92 | 86 |
| Example 47-2 | | | | | | |

### Example 48-1

A gel electrolyte secondary battery of the present Example was obtained by following the same operations as in Example 37-1, except that a negative electrode mixture slurry obtained by uniformly mixing 92.0 parts by weight of artificial graphite as a negative electrode active substance and 0.80 parts by weight of PVdF and 7.20 parts by weight of SBR as a binder and adding NMP was used in the preparation of a negative electrode.

### Examples 48-2 to 48-5 and Comparative Examples 48-1 to 48-2

Gel electrolyte secondary batteries of the respective Examples were obtained by following the same operations as in Example 48-1, except for changing the blending proportion of PVdF to SBR in the binder of the negative electrode as shown in Table 48. Specifications of the foregoing respective Examples are shown in Table 48.

TABLE 48

| | Binder (8.0%) | | | | Load | Cycle |
|---|---|---|---|---|---|---|
| | | PVdF | SBR | Battery capacity | characteristic | characteristic |
| | PVdF/SBR | (parts by weight) | (parts by weight) | (mAh) | (%) | (%) |
| Example 48-1 | 10/90 | 0.80 | 7.20 | 769 | 74 | 59 |
| Example 48-2 | 30/70 | 2.40 | 5.60 | 769 | 74 | 69 |
| Example 48-3 | 50/50 | 4.00 | 4.00 | 769 | 74 | 77 |
| Example 48-4 | 70/30 | 5.60 | 2.40 | 769 | 74 | 85 |
| Example 48-5 | 90/10 | 7.20 | 0.80 | 769 | 74 | 86 |
| Comparative | 0/100 | 0.00 | 8.00 | 769 | 74 | 50 |
| Example 48-1 | | | | | | |
| Comparative | 100/0 | 8.00 | 0.00 | 769 | 74 | 81 |
| Example 48-2 | | | | | | |

### [Performance Evaluation]

A sample of the gel electrolyte secondary battery of each of the foregoing Examples and Comparative Examples was evaluated in the following measurement methods. Five of the samples were measured in each of the tests on each level, and average values thereof were taken and evaluated. Also, since the measured capacity of the sample of the gel electrolyte secondary battery of each of the foregoing Examples and Comparative Examples was from 785 to 841 mAh, the rated capacity was defined to be 800 mAh. In the case where the rated capacity is 800 mAh, 0.2 C, 1 C and 2 C become 160 mA, 800 mA and 1.6 A, respectively.

### <Evaluation of Capacity>

With respect to the initial charge just after assembling, constant-current constant-voltage charge was carried out at 0.15 C (=120 mA) until a prescribed fully charged voltage of 4.2 V. Elapse of 12 hours or decay of the current value to 0.002 C (=1.6 mA), whichever was faster, was defined to be the completion of charge, and its quantity of electricity was defined as a charge capacity. With respect to the initial discharge, constant-current discharge was carried out at 0.2 C until 3 V, and its quantity of electricity was defined as a battery capacity. The obtained results are also shown in Tables 1 to 48.

### <Evaluation of Load Characteristic>

A charge capacity at 2 C and a charge capacity at 0.2 C were measured at room temperature, and a value of load characteristic was calculated according to the following expression [1]. The obtained results are also shown in Tables 1 to 4.

Load characteristic(%)=(Discharge capacity at 2 C)/(Discharge capacity at 0.2 C)×100(%) Expression [1]

### <Evaluation of Cycle Characteristic>

Constant-current constant-voltage charge at 1 C at a prescribed voltage of 4.2 V was carried out, and discharge was also carried out under a constant-current condition at 1 C; and a charge-discharge test was repeated at a discharge cutoff of 2.5 V.

A change with time of the discharge capacity obtained at every cycle was measured, and a value of cycle characteristic was calculated according to the following expression [2]. The obtained results are also shown in Tables 1 to 48. The case where this value was 90% or more was defined to be non-defective.

Cycle characteristic(%)=(Discharge capacity at the 200th cycle)/(Discharge capacity at the 5th cycle)×100(%) Expression [2]

<Evaluation of Increasing Amount of Thickness of Battery after Cycle>

A battery after 200 cycles was fully charged to a voltage (4.20 V) of the specifications for designing the battery by means of prescribed standard charge, and an increasing amount of thickness of the battery after 200 cycles was measured. The obtained results are also shown in Tables 1 to 36.

It is understood from Tables 1 to 36 that in Example 1-1 to Example 36-3 falling within the scope of an embodiment, the compatibility between the negative electrode and the gel non-aqueous electrolyte is kept, and therefore, the battery capacity is high, and the load characteristic and the cycle characteristic, especially the cycle characteristic is excellent as compared with Comparative Example 1-1 to Comparative Example 36-2 falling outside the scope of an embodiment.

From the viewpoints that the battery capacity is high and that the load characteristic and the cycle characteristic are excellent, the total content of PVdF and PAN is preferably from 2.0 to 6.5%, and a ratio of PVdF to PAN is preferably from 5/95 to 95/5 in terms of a weight ratio.

For example, when the amount of the binder of the negative electrode is less than 1.0%, the strength of the negative electrode mixture layer is weak, and there is a possibility that the mixture layer is peeled away during the cycle to cause cycle deterioration. On the other hand, when the amount of the binder of the negative electrode exceeds 8.0%, there is a possibility of causing a lowering of the capacity, deterioration of the load characteristic and cycle deterioration.

Also, from the viewpoint of reducing the increasing amount of the thickness after cycle, the total content of PVdF and PAN is preferably from 2.0 to 6.5%, and a ratio of PVdF to PAN is preferably from 5/50 to 95/50 in terms of a weight ratio.

In case of only PAN, since the compatibility between the negative electrode and the gel non-aqueous electrolyte was lowered, the cycle characteristic was lowered. Also, the increasing amount of the thickness after cycle increased due to the deposition of lithium.

In case of only PVdF, swelling of the electrode occurred during cycle, and the cycle characteristic was lowered. Also, the increasing amount of the thickness after cycle largely increased.

It is understood from Tables 37 to 48 that in Example 37-1 to Example 48-5 falling within the scope of an embodiment, the compatibility between the negative electrode and the gel non-aqueous electrolyte is kept, and therefore, the battery capacity is high, and the load characteristic and the cycle characteristic, especially the cycle characteristic is excellent as compared with Comparative Example 37-1 to Comparative Example 48-2 falling outside the scope of an embodiment.

From the viewpoints that the battery capacity is high and that the load characteristic and the cycle characteristic are excellent, the total content of PVdF and SBR is preferably from 2.5 to 6.5%, and a ratio of PVdF to SBR is preferably from 90/30 to 10/70 in terms of a weight ratio.

For example, when the amount of the binder of the negative electrode is less than 1.0%, the strength of the negative electrode mixture layer is weak, and there is a possibility that the mixture layer is peeled away during the cycle to cause cycle deterioration. On the other hand, when the amount of the binder of the negative electrode exceeds 8.0%, since the active species necessary for the battery reaction lowers the reaction area, there is a possibility of causing a lowering of the capacity, deterioration of the load characteristic and cycle deterioration.

In case of only SBR, since the compatibility between the negative electrode and the gel non-aqueous electrolyte was lowered, the cycle characteristic was lowered. Also, the increasing amount of the thickness after cycle increased due to the deposition of lithium.

In case of only PVdF, swelling of the electrode occurred during cycle, and the cycle characteristic was lowered.

While the present disclosure has been described with reference to certain embodiments and specific examples thereof, it should be appreciated that the embodiments are not limited thereto, and various changes and modifications can be made therein within the spirit and scope of the present invention.

For example, in the foregoing embodiments, the case where the battery element 20 having the negative electrode 21 and the positive electrode 22 laminated and wound therein is provided has been described. However, the embodiments can also be applied to the case where a plate battery element having a pair of a positive electrode and a negative electrode laminated therein is provided, or the case where a lamination type battery element having plural positive electrodes and negative electrodes laminated therein is provided.

Also, in the foregoing embodiments, the case where the film exterior member 30 is used has been described. However, the present invention can also be applied to batteries of a so-called cylindrical type using a can for the exterior member and those having other shape such as a rectangular type, a coin-shaped type and a button-shaped type. Furthermore, the present invention can be applied to not only a secondary battery but a primary battery.

Although the embodiments has been described above with reference to a battery using lithium as an electrode reaction substance, the technical concept of the invention can also be applied to the cases using another alkaline metal such as sodium (Na) and potassium (K), an alkaline earth metal such as magnesium (Mg) and calcium (Ca), or another light metal such as aluminum.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gel electrolyte secondary battery comprising:
a positive electrode;
a negative electrode including a binder-containing negative electrode mixture; and
a gel non-aqueous electrolyte, wherein
the binder includes
polyvinylidene fluoride, and
polyacrylonitrile or a styrene-butadiene rubber.

2. The gel electrolyte secondary battery according to claim 1, wherein
the gel non-aqueous electrolyte includes a matrix polymer; and
the matrix polymer includes at least one member selected from the group consisting of a copolymer of polyvinylidene fluoride and hexafluoropropylene, a copolymer of polyvinylidene fluoride, hexafluoropropylene and monochlorotrifluoroethylene, and a copolymer of polyvinylidene fluoride, hexafluoropropylene and monomethyl maleate.

3. The gel electrolyte secondary battery according to claim 1, wherein
the binder includes polyvinylidene fluoride and polyacrylonitrile;
the total content of polyvinylidene fluoride and polyacrylonitrile is from 2.0 to 6.5% on the basis of the whole content of a negative electrode mixture; and
a ratio of polyvinylidene fluoride to polyacrylonitrile is from 5/95 to 95/5 in terms of a weight ratio.

4. The gel electrolyte secondary battery according to claim 1, wherein
the binder includes polyvinylidene fluoride and a styrene-butadiene rubber;
the total content of polyvinylidene fluoride and the styrene-butadiene rubber is from 2.5 to 6.5% on the basis of the whole content of a negative electrode mixture; and
a ratio of polyvinylidene fluoride to the styrene-butadiene rubber is from 90/10 to 30/70 in terms of a weight ratio.
